(19) United States
(12) Patent Application Publication
(10) Pub. No.: US 2020/0320951 A1
(43) Pub. Date: Oct. 8, 2020

(54) DISPLAY DEVICE

(71) Applicant: SAMSUNG DISPLAY CO., LTD., Yongin-si (KR)

(72) Inventor: DONG HEE SHIN, Asan-si (KR)

(21) Appl. No.: 16/685,791

(22) Filed: Nov. 15, 2019

(30) Foreign Application Priority Data
Apr. 8, 2019 (KR) 10-2019-0040886

(51) Int. Cl. G09G 3/36; G06F 1/16; G02F 1/1333

(52) U.S. Cl. CPC G09G 3/3688; G09G 3/3677; G09G 2380/02; G02F 1/133305; G06F 1/1652

(57) ABSTRACT

A display device is provided including a display panel including data lines which extend in a first direction and a display area which includes a plurality of data areas along a second direction that intersects the first direction. First flexible films are disposed on a first side of the display panel. Second flexible films are disposed on a second side of the display panel. The first flexible films are electrically connected to data lines in odd-numbered data areas, and the second flexible films are electrically connected to data lines in even-numbered data areas.

This non-provisional utility patent application claims priority under 35 U.S.C § 119 to Korean Patent Application No. 10-2019-0040886, filed on Apr. 8, 2019, in the Korean Intellectual Property Office (KIPO), the disclosure of which is incorporated by reference herein in its entirety.

### 1. TECHNICAL FIELD

The present invention relates to a display device.

### 2. DISCUSSION OF THE RELATED ART

A liquid crystal display (LCD) device, which is one of the most widely-used display devices, includes two substrates on which field-generating electrodes, such as pixel electrodes and a common electrode, are formed. A liquid crystal layer is inserted between the two substrates. The LCD applies voltages to the field-generating electrodes to generate an electric field in the liquid crystal layer and determine the orientation of liquid crystal molecules in the liquid crystal layer, thereby controlling the polarization of incident light to display images.

A vertical alignment-mode LCD device, which is a type of LCD device that aligns the major axis of liquid crystal molecules to be perpendicular to upper and lower display panels in the absence of an electric field, has become increasingly popular because of its excellent contrast ratio and ease of effectuating wide viewing angles.

A high-resolution LCD device such as a Quad Ultra High Definition (QUHD) LCD device has recently been released. The QUHD LCD device has a resolution of 7860×4320, which is four times higher than the resolution of an Ultra High Definition (UHD) LCD device. The QUHD LCD device includes twice as many data lines as the UHD LCD device and thus has a small pitch between the data lines. The pitch between the data lines may refer to the distance between a pair of adjacent data lines. In this case, the pitch between data pads connected to the data lines may be even smaller, and thus a chip-on-film (COF) may not be properly attached to the data pads. For example, when attaching a COF to the data pads, pairs of adjacent data pads may be short-circuited by the lead pads of the COF.

### SUMMARY

According to an exemplary embodiment of the present invention, a display device is provided including a display panel including data lines which extend in a first direction and a display area which includes a plurality of data areas along a second direction that intersects the first direction. First flexible films are disposed on a first side of the display panel. Second flexible films are disposed on a second side of the display panel. The first flexible films are electrically connected to data lines in odd-numbered data areas, and the second flexible films are electrically connected to data lines in even-numbered data areas.

According to an exemplary embodiment of the present invention, a width in the second direction of a first flexible film of the first flexible films is greater than a width in the second direction of an odd-numbered data area connected to the first flexible film.

According to an exemplary embodiment of the present invention, a width in the second direction of a second flexible film of the second flexible films is greater than a width in the second direction of an even-numbered data area connected to the second flexible film.

According to an exemplary embodiment of the present invention, the first flexible films and the second flexible films electrically connected to adjacent data areas of the plurality of data areas partially overlap with each other.

According to an exemplary embodiment of the present invention, an overlapping area in the first direction of the first flexible films and the second flexible films electrically connected to the adjacent data areas is smaller than a non-overlapping area of the first flexible films and the second flexible films electrically connected to the adjacent data areas.

According to an exemplary embodiment of the present invention, first source driving circuits are respectively disposed on the first flexible films and second source driving circuits respectively disposed on the second flexible films.

According to an exemplary embodiment of the present invention, the first source driving as circuits overlap with the odd-numbered data areas. The second source driving circuits overlap with the even-numbered data areas, and the first source driving circuits do not overlap with the second source driving circuits.

According to an exemplary embodiment of the present invention, a first scan driver is adjacent to a third side of the display panel. A second scan driver is adjacent to a fourth side of the display panel. The display panel further includes scan lines which are electrically connected to the first scan driver and the second scan driver and intersect the data lines and pixels, first scan control signal lines which connect the first scan driver and first pads, and second scan control signal lines which connect the second scan driver and second pads.

According to an exemplary embodiment of the present invention, a first flexible film of the first flexible films adjacent to the third side of the display panel is electrically connected to the first pads. A second flexible film of the second flexible films adjacent to the fourth side of the display panel is electrically connected to the second pads.

According to an exemplary embodiment of the present invention, lengths of the first scan control signal lines are smaller than lengths of the second scan control signal lines.

According to an exemplary embodiment of the present invention, an odd-numbered data area adjacent to the third side of the display panel is closer to the first scan driver than an even-numbered data area adjacent to the third side of the display panel is to the first scan driver. An odd-numbered data area adjacent to the fourth side of the display panel is further away from the second scan driver than an even-numbered data area adjacent to the fourth side of the display panel is from the second scan driver.

According to an exemplary embodiment of the present invention, the first scan driver sequentially outputs scan signals to the scan lines from the first side of the display panel to the second side of the display panel.

According to an exemplary embodiment of the present invention, the display panel further includes first dummy pads which are adjacent to the first scan driver, and a second flexible film adjacent to the third side of the display panel is connected to the first dummy pads.

According to an exemplary embodiment of the present invention, the display panel further includes second dummy pads which are adjacent to the second scan driver, and the second flexible film adjacent to the fourth side of the display panel is connected to the second dummy pads.

According to an exemplary embodiment of the present invention, a display panel includes a plurality of data areas. Each data area of the plurality of data areas includes a first data line and a second data line. A plurality of pixels are disposed in a column between the first data line and the second data line of each data area, wherein adjacent pixels of the plurality of pixels are connected to the first data line and the second data line in an alternating manner. A first scan driver is adjacent to a third side of the display panel and a second scan driver is adjacent to a fourth side of the display panel, each including scan control signal lines which are electrically connected to outermost ones of the data areas. A first scan control signal line connects the first scan driver and first pads, and a second scan control signal line connects the second scan driver and second pads. First flexible films are disposed on a first side of the display panel with a first distance therebetween, and second flexible films are disposed on a second side of the display panel opposite to the first side with a second space therebetween. The first flexible films are electrically connected to odd-numbered data areas. The second flexible films are electrically connected to even-numbered data areas. Scan lines are electrically connected to the first scan driver and the second scan driver and intersect the first data line and the second data line and the plurality of pixels. At least some of the scan lines are bifurcated and connect to adjacent pixels in the same column. A first flexible film of the first flexible films adjacent to the third side of the display panel is electrically connected to the first pads, and a second flexible film of the second flexible films adjacent to the fourth side of the display panel is electrically connected to the second pads.

According to an exemplary embodiment of the present invention, a length of one of the first scan control signal lines is the same as a length of one of the second scan control signal lines.

According to an exemplary embodiment of the present invention, an odd-numbered data area adjacent to the third side of the display panel is closer to the first scan driver than an even-numbered data area adjacent to the third side of the display panel is to the first scan driver. An odd-numbered data area adjacent to the fourth side of the display panel is further apart than an even-numbered data area adjacent to the fourth side of the display panel from the second scan driver.

According to an exemplary embodiment of the present invention, the first scan driver sequentially outputs scan signals to the scan lines from the first side of the display panel to the second side of the display panel.

According to an exemplary embodiment of the present invention, the display panel as further includes first dummy pads which are adjacent to the first scan driver, and a second flexible film adjacent to the third side of the display panel is connected to the first dummy pads.

According to an exemplary embodiment of the present invention, the display panel further includes second dummy pads which are adjacent to the second scan driver, and a first flexible film adjacent to the fourth side of the display panel is connected to the second dummy pads.

### BRIEF DESCRIPTION OF THE DRAWINGS

The above and other features of the present invention will become more apparent by describing in detail exemplary embodiments thereof with reference to the attached drawings, in which:

FIG. 1 is a perspective view of a display device according to an exemplary embodiment of the present invention;

FIG. 2 is a plan view illustrating a display panel including first flexible films and second flexible films according to an exemplary embodiment of the display device shown in FIG. 1;

FIG. 3 is a circuit diagram illustrating first pixels and second pixels in a first data area of FIG. 2 according to an exemplary embodiment of the present invention;

FIG. 4 is a plan view illustrating the first pixels and second pixels in a first data area of FIG. 2 according to an exemplary embodiment of the present invention;

FIG. 5 is a cross-sectional view taken along line I-I′ of FIG. 4 according to an exemplary embodiment of the present invention;

FIG. 6 illustrates a first scan driver of the display panel of FIG. 2 according to an exemplary embodiment of the present invention;

FIG. 7 illustrates a second scan driver of the display panel of FIG. 2 according to an exemplary embodiment of the present invention;

FIG. 8 illustrates a stage of FIG. 6 according to an exemplary embodiment of the present invention;

FIG. 9A is a plan view illustrating a first fan-out area of FIG. 2 according to an exemplary embodiment of the present invention;

FIG. 9B is a plan view illustrating a second fan-out area of FIG. 2;

FIG. 10 is a cross-sectional view taken along line II-II′ of FIG. 9A according to an exemplary embodiment of the present invention;

FIGS. 11 and 12 illustrate fan-out lines in the first data area of FIG. 2 according to an exemplary embodiment of the present invention;

FIG. 13A is a plan view illustrating a twenty-third fan-out area of FIG. 2 according to an exemplary embodiment of the present invention;

FIG. 13B is a plan view illustrating a twenty-fourth fan-out area of FIG. 2;

FIG. 14 is a cross-sectional view taken along line III-III′ of FIG. 13A according to an exemplary embodiment of the present invention;

FIG. 15 is a plan view illustrating a display panel including first flexible films and second flexible films according to an exemplary embodiment of the display device shown in FIG. 1;

FIG. 16 is a plan view illustrating a twenty-fourth fan-out area of FIG. 15 according to an exemplary embodiment of the present invention; and

FIG. 17 is a perspective view of a display device according to according to an exemplary embodiment of the present invention.

### DETAILED DESCRIPTION OF THE EMBODIMENTS

Exemplary embodiments of the present invention will now be described with reference to the accompanying drawings. The present invention may, however, be embodied in many different forms and should not be construed as being limited to the exemplary embodiments set forth herein. Like reference numerals may refer to like elements throughout the detailed description and drawings. In the attached figures, the dimensions of elements may be exaggerated for clarity of illustration.

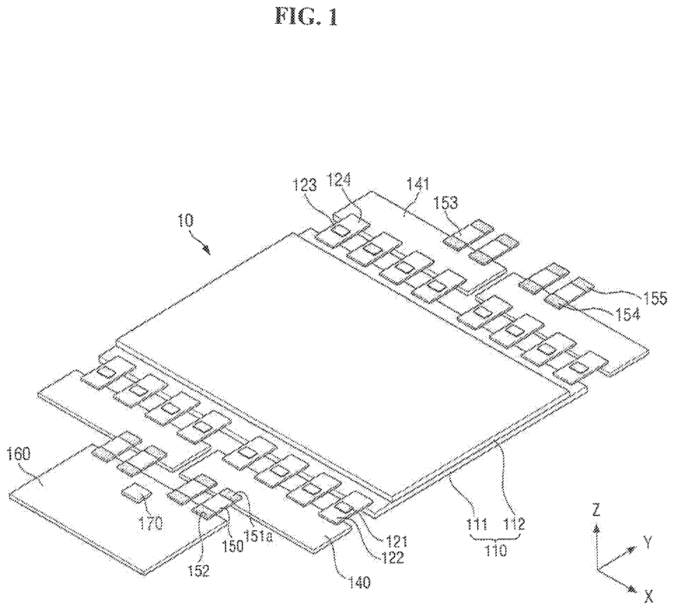

It will be understood that when a layer is referred to as being “on” another layer or substrate, it can be directly on the other layer or substrate, or intervening layers may also be present. FIG. 1 is a perspective view of a display device according to an exemplary embodiment of the present invention.

Referring to FIG. 1, a display device 10 includes a display panel 110, first source driving circuits 121, first flexible films 122, second source driving circuits 123, second flexible films 124, first source circuit boards 140, second source circuit boards 141, first cables 150, second cables 153, a control circuit board 160, and a timing control circuit 170.

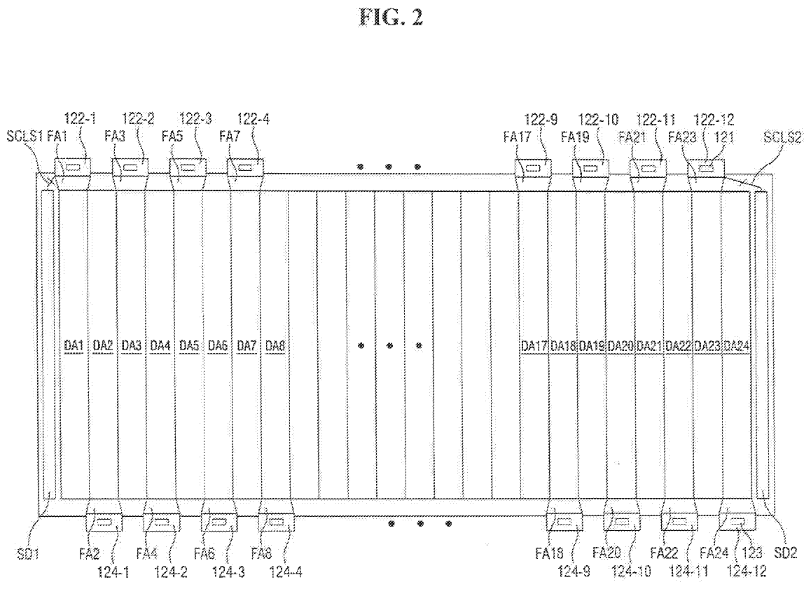

A second substrate 112 of the display panel 110 may be disposed on top, above or may be a top surface of a first substrate 111 of the display panel 110 in a Z-axis direction. In addition, the first substrate 111 may be disposed below, at the bottom or form a bottom surface of the second substrate 112 in the Z-axis direction. The display panel 110 may have a rectangular shape in a plan view. For example, the display panel 110 may be formed as a rectangle, in a plan view, having a pair of short sides extending in a first direction (e.g., a Y-axis direction) and a pair of long sides extending in a second direction (e.g., a X-axis direction). The corners at which the short sides and the long sides of the display panel 110 meet may be right-angled or may be rounded to have a predetermined curvature. The planar shape of the display panel 110 is not particularly limited, and the display panel 110 may be formed in various shapes other than a rectangular shape, such as another polygonal shape, a circular shape, or an elliptical shape. FIG. 2 illustrates the display panel 110 as being flat, but the present invention is not limited thereto. For example, the display panel 110 may be curved to have a predetermined curvature.

The display panel 110 may include the first substrate 111 and the second substrate 112. The first substrate 111 and the second substrate 112 may be formed of glass and/or plastic. The display panel 110 may be implemented as a liquid crystal display (LCD) panel including the first substrate 111 and the second substrate 112 and a liquid crystal layer may be disposed between the first and second substrates 111 and 112.

The length of the second substrate 112 in the first direction (e.g., the Y-axis direction) may be smaller than the length of the first substrate 111 in the first direction (e.g., the Y-axis direction). For example, a first surface of the first substrate 111 may not be covered by the second substrate 112 on a first side and a second side of the display panel 110. The second side of the display panel 110 may refer to the opposite side, in the first direction (e.g., the Y-axis direction) from the first side of the display panel 110. Referring to FIG. 1, the first side of the display panel 110 may also be referred to as a lower side of the display panel 110, and the second side of the display panel 110 may also be referred to as an upper side of the display panel 110. For example, the first side and the second side of the display panel 110 may refer to long sides of the display panel 110.

A first scan driver SD1 (shown in FIG. 2) may be disposed on a third side of the display panel 110 (e.g., a first short side extending in the Y-axis direction), and a second scan driver SD2 (shown in FIG. 2) may be disposed on a fourth side of the display panel 110 (e.g., a second short side opposite to the first short side and extending in the Y-axis direction). Referring to FIG. 1, the third side of the display panel 110 may be a left side of the display panel 110, and the fourth side of the display panel 110 may be a right side of the display panel 110.

The first scan driver SD1 may generate first scan signals in accordance with first scan control signals from the timing control circuit 170 and may sequentially output the first scan signals to scan lines of the display panel 110. The second scan driver SD2 may generate second scan signals in accordance with second scan control signals from the timing control circuit 170 and may sequentially output the second scan signals to the scan lines of the display panel 110. The first scan signals may be synchronized with the second scan signals.

The first flexible films 122-1 to 122-12 may be disposed on the lower side, in the first direction (e.g., the Y-axis direction), of the display panel 110. The second flexible films 124-1 to 124-12 may be disposed on the upper side, in the first direction (e.g. the Y-axis direction), of the display panel 110.

First sides of the first flexible films 122 may not be covered by the second substrate 112, but may be attached to an exposed part of the first surface of the first substrate 111. Second sides of the first flexible films 122 may be attached to a first surface of one of the first source circuit boards 140. The first sides and the second sides of the first flexible films 122 may be spaced apart in the first direction (e.g., the Y-axis direction). The first flexible films 122 may be attached to the first surfaces of the first substrate 111 and one of the first source circuit boards 140 via anisotropic conductive films (ACFs). The first flexible films 122 may be spaced apart in the second direction (e.g., the X-axis direction).

First sides of the second flexible films 124 may not be covered by the second substrate 112 and may be attached to the exposed part of the first surface of the first substrate 111. Second sides of the second flexible films 124 may be attached to a first surface of one of the second source circuit boards 141. The first sides and the second sides of the second flexible films 124 may be spaced apart in the first direction (e.g., the Y-axis direction). The second flexible films 124 may be attached to the first surfaces of the first substrate 111 and one of the second source circuit boards 141 via ACFs. The second flexible films 124 may be spaced apart in the second direction (e.g., the X-axis direction).

The first flexible films 122 and the second flexible films 124 may be flexible films that can be bent or folded, such as tape carrier packages (TCPs) and/or chip-on-films (COFs). The first flexible films 122 and the second flexible films 124 may be bent in a downward direction from the first substrate 111 (e.g., toward a second surface of the display device 110). For example, the first source circuit board 140, the second source circuit boards 141, the first cables 150, the second cables 153, the control circuit board 160, and the timing control circuit 170 may be disposed below the first substrate 111.

FIG. 2 illustrates that eight first flexible films 122 (122-1 to 122-4 and 122-9 to 122-12) and eight second flexible films 124 (124-1 to 124-4 and 124-9 to 124-12) are attached on the first substrate 111 of the display panel 110, but the numbers of first flexible films 122 and second flexible films 124 are not particularly limited. For example, in a case where the display panel 110 has a high resolution such as the Quad Ultra High Definition (QUHD) resolution, the numbers of first flexible films 122 and second flexible films 124 may increase. The QUHD resolution refers to a resolution of 7860×4320, which is four times higher than the Ultra High Definition (UHD) resolution.

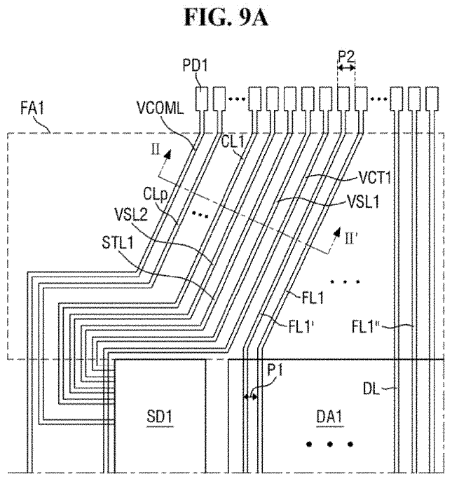

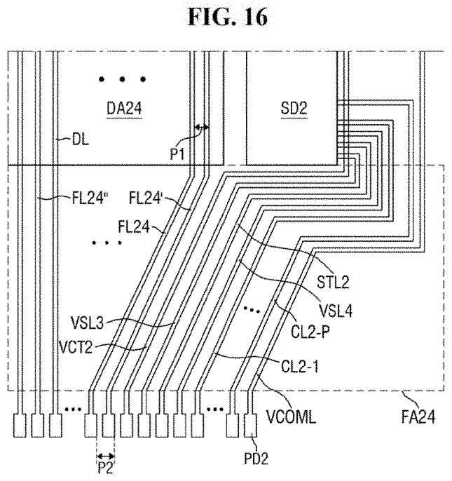

The numbers of first flexible films 122 and second flexible films 124 may vary depending on the number of channels of each of the first flexible films 122 and the number of channels of each of the second flexible films 124. The number of channels of each of the first flexible films 122 may refer to the number of lead pads of each of the first flexible films 122 that are connected to first pads PD1 (shown in FIG. 9A) of the display panel 110. The number of channels of each of the second flexible films 124 may refer to the number of lead pads of each of the second flexible films 124 that are connected to second pads PD2 (shown in FIG. 16) of the display panel 110.

The first source driving circuits 121 may be disposed on the first flexible films 122. The first source driving circuits 121 may be disposed between the first side and the second side of the first flexible films 122. For example, the first source driving circuits 121 may be disposed on the first flexible films 122 overlapping a gap between the first substrate 111 and one of the first source circuit boards 140. The first source driving circuits 121 may be formed as integrated circuits (ICs). The first source driving circuits 121 convert digital video data into analog data voltages in accordance with a first source control signal from the timing control circuit 170 and output the analog data voltages to data lines of the display panel 110 via the first flexible films 122.

The second source driving circuits 123 may be disposed on the second flexible films 124. The second source driving circuits 123 may be disposed between the first side and the second side of the second flexible films 124. For example, the second source driving circuits 123 may be disposed on the second flexible films 124 overlapping a gap between the first substrate 111 and one of the second source circuit boards 141. The second source driving circuits 123 may be formed as ICs. The second source driving circuits 123 convert the digital video data into analog data voltages in accordance with a second source control signal from the timing control circuit 170 and output the analog data voltages to the data lines of the display panel 110 via the second flexible films 124.

The first source circuit boards 140 may be connected to the control circuit board 160 via the first cables 150. Each of the first source circuit boards 140 may include first connectors 151a which are connected to the first cables 150.

The second source circuit boards 141 may be connected to the control circuit board 160 via the second cables 153. Each of the second source circuit boards 141 may include third connectors 154 which are connected to the second cables 153.

The first source circuit boards 140 and the second source circuit boards 141 may be printed circuit boards (PCBs) and/or flexible printed circuit boards (FPCBs). The first cables 150 and the second cables 153 may be flexible cables.

The control circuit board 160 may be connected to the first source circuit boards 140 via the first cables 150. For example, the control circuit board 160 may include second connectors 152 which are connected to the first cables 150. The control circuit board 160 may be connected to the second source circuit boards 141 via the second cables 153. For example, when the first flexible films 122 and the second flexible films 124 are bent such that the control circuit board 160, the first source circuit boards 140, and the second source circuit boards 141 are disposed below the second substrate 112, the second source circuit board 160 may connect to the second cable 153 at a rear surface thereof. The control circuit board 160 may include fourth connectors 155 which are connected to the second cables 153. The control circuit board 160 may be a PCB and/or an FPCB.

FIG. 1 illustrates that four first cables 150 are provided to connect the first source circuit boards 140 and the control circuit board 160, and that four second cables 153 are provided to connect the second source circuit boards 141 and the control circuit board 160, but the numbers of first cables 150 and second cables 153 are not particularly limited. Also, FIG. 1 illustrates that two first source circuit boards 140 and two second source circuit boards 141 are provided, but the numbers of first source circuit boards 140 and second source circuit boards 141 are not particularly limited. Although the first circuit boards 140 and the second circuit boards 141 are illustrated as parallel to opposite sides of the first substrate 111, respectively, the present invention is not limited thereto. For example, the first circuit boards 140 and the second circuit boards 141 may be angled away from a first side and a second side of the first substrate 111, respectively, and lengths of the first flexible films 122 and second flexible films 124 may be adjusted accordingly.

The timing control circuit 170 may be disposed on the control circuit board 160. The timing control circuit 170 may be formed as an integrated circuit (IC). The timing control circuit 170 may receive digital video data and timing signals from a system-on-chip of a system circuit board. The timing control circuit 170 may generate the first source control signal, which is for controlling the timings of the first source driving circuits 121, and the second source control signal, which is for controlling the timings of the second source driving circuits 123, in accordance with the timing signals. The timing control circuit 170 may generate the first scan control signals, which are for controlling the timing of the first scan driver SD1, and the second scan control signals, which are for controlling the timing of the second scan driver SD2, in accordance with the timing signals.

The system-on-chip may be mounted on the system circuit board connected to the control circuit board 160 via a flexible cable and may be formed as an IC. The system-on-chip may be a processor of a smart television (TV), a central processing unit (CPU), a graphics card of a computer or a notebook computer, or an application processor of a smartphone or a tablet personal computer (PC). The system circuit board may be a PCB or an FPCB.

A power supply circuit may be additionally attached on a first surface of the control circuit board 160. The power supply circuit may generate voltages for driving the display panel 110 from main power applied thereto from the system circuit board and may provide the voltages to the display panel 110. The power supply circuit may generate and provide driving voltages for driving the first scan driver SD1, the second scan driver SD2, the first source driving circuits 121, the second source driving circuits 123, and the timing control circuit 170. The power supply circuit may be formed as an IC. For example, the power supply circuit may be disposed on a power circuit board which is separate from the control circuit board 160. The power circuit board may be a PCB or an FPCB.

FIG. 2 is a plan view illustrating a display panel including first flexible films 122 and second flexible films 124 according to an exemplary embodiment of the display device of FIG. 1.

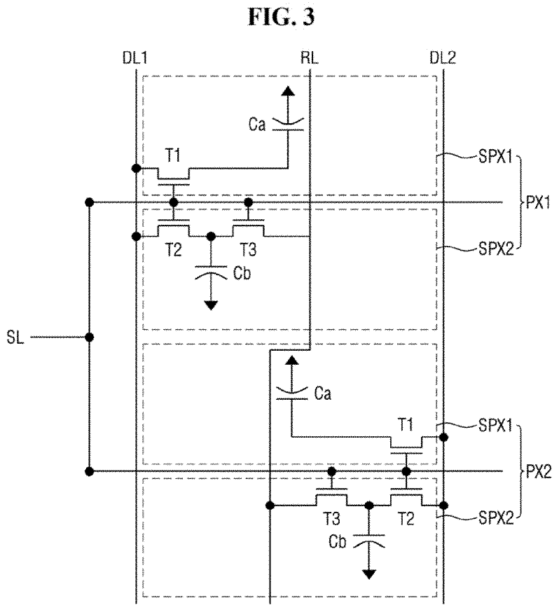

The display panel 110 may include data lines which extend in the first direction (e.g., the Y-axis direction), scan lines which extend in the second direction (e.g., the X-axis direction) to intersect the data lines, and a display area DA which includes pixels that are disposed in regions defined by the data lines and the scan lines. The pixels will be described later with reference to FIGS. 3 through 5.

The display area DA of the display panel 110 may include a plurality of data areas which are arranged in the second direction (e.g., the X-axis direction). For example, as illustrated in FIG. 2, the display panel 110 may include first through twenty-fourth data areas DA1 through DA24. However, the number of data areas and associated first flexible films 122 and second flexible films 124 is not particularly limited. For convenience of illustration and description, the ninth through fifteenth data areas DA9 through DAIS are not illustrated in FIG. 2.

The first through twenty-fourth data areas DA1 through DA24 may all include the same number of data lines. According to an exemplary embodiment of the present invention, the first, second, twenty-third, and twenty-fourth data areas DA1, DA2, DA23, and DA24 may include the same number of data lines, and the remainder of the data areas may include a number of data lines different from the first, second, twenty-third, and twenty-fourth data areas DA1, DA2, DA23, and DA24.

Data lines in odd-numbered data areas from the left of the display panel 110 may be electrically connected to first flexible films 122(122-1 to 122-12) which are disposed on the upper side of the display panel 110. Data lines in the first data area DA1 may be electrically connected to the first flexible film 122-1, and data lines in the third data area DA3 may be electrically connected to the first flexible film 122-2. Data lines in the fifth data area DA5 may be electrically connected to the first flexible film 122-3, and data lines in the seventh data area DA7 may be electrically connected to the first flexible film 122-4. Data lines in the seventeenth data area DA17 may be electrically connected to the first flexible film 122-9, and data lines in the nineteenth data area DA19 may be electrically connected to the first flexible film 122-10. Data lines in the twenty-first data area DA21 may be electrically connected to the first flexible film 122-11, and data lines in the twenty-third data area DA23 may be electrically connected to the first flexible film 122-12.

Data lines in even-numbered data areas from the left of the display panel 110 may be electrically connected to second flexible films 124 (124-1 to 124-12) which are disposed on the lower side of the display panel 110. Data lines in the second data area DA2 may be electrically connected to the second flexible film 124-1, and data lines in the fourth data area DA4 may be electrically connected to the second flexible film 124-2. Data lines in the sixth data area DA6 may be electrically connected to the second flexible film 124-3, and data lines in the eighth data area DA8 may be electrically connected to the second flexible film 124-4. Data lines in the eighteenth data area DA18 may be electrically connected to the second flexible film 124-9, and data lines in the twentieth data area DA20 may be electrically connected to the second flexible film 124-10. Data lines in the twenty-second data area DA22 may be electrically connected to the second flexible film 124-11, and data lines in the twenty-fourth data area DA24 may be electrically connected to the second flexible film 124-12.

For convenience of explanation and illustration, the ninth through sixteenth data areas DA9 through DA16, which are disposed between the eighth and seventeenth data areas DA8 and DA17 and and corresponding first flexible films 122 and second flexible films 124 are not illustrated in FIG. 2.

The display panel 110 may include odd-numbered fan-out areas which are disposed between the odd-numbered data areas and the first flexible films 122. A first fan-out area FA1 may include first fan-out lines which are disposed between the first data area DA1 and the first flexible film 122-1. A third fan-out area FA3 may include third fan-out lines which are disposed between the third data area DA3 and the first flexible film 122-2. A fifth fan-out area FA5 may include fifth fan-out lines which are disposed between the fifth data area DA5 and the first flexible film 122-3. A seventh fan-out area FA7 may include seventh fan-out lines which are disposed between the seventh data area DA7 and the first flexible film 122-4. A seventeenth fan-out area FA17 may include seventeenth fan-out lines which are disposed between the seventeenth data area DA17 and the first flexible film 122-9. A nineteenth fan-out area FA19 may include nineteenth fan-out lines which are disposed between the nineteenth data area DA19 and the first flexible film 122-10. A twenty-first fan-out area FA21 may include twenty-first fan-out lines which are disposed between the twenty-first data area DA21 and the first flexible film 122-11. A twenty-third fan-out area FA23 may include twenty-third fan-out lines which are disposed between the twenty-third data area DA23 and the first flexible film 122-12.

According to an exemplary embodiment of the present invention, the width of sides of the odd-numbered fan-out areas adjacent to the odd-numbered data areas may be smaller than the width of sides of the odd-numbered fan-out areas adjacent to the first flexible films (1211 through 1222). For example, the odd-numbered fan-out areas may have a width that tapers in a direction from the odd-numbered fan-out areas towards the odd-numbered data areas. The more similar the width of first sides of the odd-numbered fan-out areas is to the width of second sides of the odd-numbered fan-out areas the easier it becomes to design the odd-numbered fan-out lines. The width, in the first direction (e.g., the Y-axis direction) of the odd-numbered fan-out areas may be reduced. As a result, the bezel size on the upper side of the display panel 110 can be reduced. According to an exemplary embodiment of the present invention, the width of the odd-numbered fan-out areas adjacent to the first flexible films 122 may be wider in the second direction (e.g., the X-axis direction) than the width of the odd-numbered display areas connected thereto.

The display panel 110 may include even-numbered fan-out areas which are disposed between the even-numbered data areas and the second flexible films 124-1 to 124-12. A second fan-out area FA2 may include second fan-out lines which are disposed between the second data area DA2 and the second flexible film 124-1. A fourth fan-out area FA4 may include fourth fan-out lines which are disposed between the fourth data area DA4 and the second flexible film 124-2. A sixth fan-out area FA6 may include sixth fan-out lines which are disposed between the sixth data area DA6 and the second flexible film 124-3. An eighth fan-out area FA8 may include eighth fan-out lines which are disposed between the eighth data area DA8 and the second flexible film 124-4. An eighteenth fan-out area FA18 may include eighteenth fan-out lines which are disposed between the eighteenth data area DA18 and the second flexible film 124-9. A twentieth fan-out area FA20 may include twentieth fan-out lines which are disposed between the twentieth data area DA20 and the second flexible film 124-10. A twenty-second fan-out area FA22 may include twenty-second fan-out lines which are disposed between the twenty-second data area DA22 and the second flexible film 124-11. A twenty-fourth fan-out area FA24 may include twenty-fourth fan-out lines which are disposed between the twenty-fourth data area DA24 and the second flexible film 124-12.

The width of sides of the even-numbered fan-out areas adjacent to the even-numbered data areas may be smaller than the width of sides of the even-numbered fan-out areas adjacent to the second flexible films 124-1 to 124-12. The more similar the width of first sides of the even-numbered fan-out areas is to the width of second sides of the even-numbered fan-out areas the easier it becomes to design the even-numbered fan-out lines. The width in the first direction (e.g., the Y-axis direction) of the even-numbered fan-out areas may be reduced. As a result, the bezel size on the lower side of the display panel 110 can be reduced.

The first flexible films 122-1 to 122-12, which are disposed on the upper side of the display panel 110, may correspond to the odd-numbered data areas, and the second flexible films 124-1 to 124-12, which are disposed on the lower side of the display panel 110, may correspond to the even-numbered data areas. In other words, the first flexible films 122-1 to 122-12 may be arranged in a staggered manner with the second flexible films 124-1 to 124-12. As a result, the first source driving circuits 121, which are disposed on the first flexible films 122-1 to 122-12, may overlap with the odd-numbered data areas in the first direction (e.g., the Y-axis direction), and the second source driving circuits 123, which are disposed on the second flexible films 124-1 to 124-12, may overlap with the even-numbered data areas in the first direction (e.g., the Y-axis direction). In a case where the display panel 110 has a high resolution such as the QUHD resolution, the number of data lines provided in the display panel 110 increases. Thus, as illustrated in FIG. 9A, a pitch P1 between the data lines may be smaller than a pitch P2 between the first pads PD1 of the display panel 110 or the pitch between the lead pads of each of the first flexible films 122-1 to 122-12. As a result, a width of the first flexible films 122-1 to 122-12 and a width of the second flexible films 124-1 to 124-12 may be greater than a width of the first through twenty-fourth data areas DA1 through DA24.

The first source driving circuits 121, which are disposed on the first flexible films 122-1 to 122-12, may not overlap with the second source driving circuits 123, which are disposed on the second flexible films 124-1 to 124-12, in the first direction (e.g., the Y-axis direction). For example, the first source driving circuit 121 on the first flexible film 122-1 may not overlap with the second source driving circuit 123 on the second flexible film 124-1 in the first direction (e.g., the Y-axis direction).

First flexible films 122 and second flexible films 124 electrically connected to the groups of data lines of each pair of adjacent data areas may partially overlap with each other in the first direction (e.g., the Y-axis direction). For example, the second flexible film 124-1 may partially overlap with the first flexible film 122-1 in the first direction (e.g., the Y-axis direction). The second flexible film 124-1 may partially overlap with the first flexible film 122-2.

Also, the overlapping area, in the first direction (e.g., the Y-axis direction), of the first flexible films 122 and the second flexible films 124 electrically connected to the groups of data lines of each pair of adjacent data areas may be smaller than the non-overlapping area of the first and second flexible films 122 and 124 electrically connected to the groups of data lines of each pair of adjacent data areas. For example, the overlapping area, in the first direction (e.g. the Y-axis direction), of the first flexible film 122-1 and the second flexible film 124-1 may be smaller than the non-overlapping area of the first flexible film 122-1 and the second flexible film 124-1.

A first scan driver SD1 may be disposed on the left side of the display panel 110. A second scan driver SD2 may be disposed on the right side of the display panel 110.

The first scan driver SD1 may be electrically connected to at least one of the first flexible films 122. For example, the first scan driver SD1 may be disposed adjacent to an odd-numbered data area (e.g., the first data area DA1) and may be connected to an outermost first flexible film 122 on the left side of the display panel 110, such as the first flexible film 122-1. The first scan driver SD1 may be electrically connected to the first flexible film 122-1 via first scan control lines SCLS1. For example, the first scan driver SD1 may be shorter in the first direction (e.g., the Y-axis direction) than a short side of the display panel 110 upon which it is disposed, and the first scan control lines SCLS1 may diagonally extend from an end of the first scan driver SD1 to a side surface of the first flexible film 122-1 in a region in which the first flexible film 122-1 overlaps the first substrate 111.

The second scan driver SD2 may be electrically connected to an outermost first flexible film 122 that is closest to the right side of the display panel 110, such as the first flexible film 122-12. The second scan driver SD2 may be electrically connected to the first flexible film 122-12 via second scan control lines SCLS2.

The first flexible film 122-1 is disposed to correspond to the first data area DA1, which is closest to the first scan driver SD1 in the display area DA. The first flexible film 122-12 is disposed to correspond to the twenty-third data area DA23, rather than to the twenty-fourth data area DA24, which is closest to the second scan driver SD2. Thus, the lengths of the second scan control lines SCLS2, which connect an end of the second scan driver SD2 and the first flexible film 122-12, may be greater than the length of the first scan control lines SCLS1, which connect an end of the first scan driver SD1 and the first flexible film 122-1.

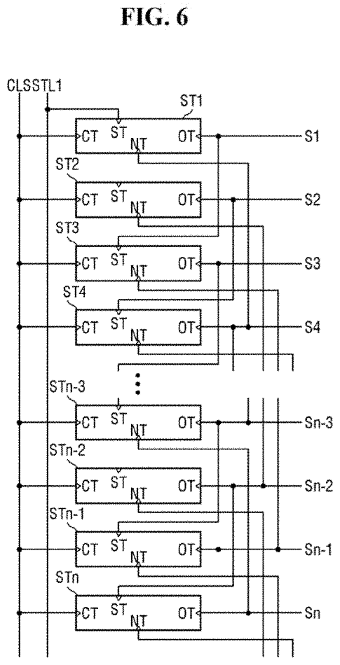

The first scan driver SD1 sequentially outputs scan signals to the scan lines of the display panel 110 in a direction from the upper side to the lower side of the display panel 110. The second scan driver SD2 sequentially outputs scan signals to the scan lines of the display panel 110 in a direction from the upper side to the lower side of the display panel 110. The first and second scan drivers SD1 and SD2 will be described later with reference to FIGS. 6 through 8.

As described above, in the display device of FIGS. 1 and 2, the first flexible films 122 are disposed on the first side of the display panel 110 (e.g., the upper side), and the second flexible films 124 are disposed on the second side of the display panel 110 (e.g., the lower side). The groups of data lines of each pair of adjacent data areas are electrically connected to first flexible films 122 and the second flexible films 124. Accordingly, the first pads PD1 disposed on the upper side of the display panel 110 and the second pads PD2 disposed on the lower side of the display panel 110 may have a greater width than the first through twenty-fourth data areas DA1 through DA24, and as a result, the width of the first flexible films 122 and the width W2 of the second flexible films 124 may be greater than the width of the first through twenty-fourth data areas DA1 through DA24. Therefore, attaching the first flexible films 122 and the second flexible films 124 to the display panel 110 can be easily performed.

The numbers of data areas, first flexible films, and second flexible films are not limited to those illustrated in FIG. 2.

FIG. 3 is a circuit diagram illustrating a first pixel PX1 and a second pixel PX2 in a first data area of FIG. 2.

For convenience of illustration, FIG. 3 illustrates only a scan line SL of the display panel 110, a first data line DL1 and a second data line DL2 of the display panel 110, which are adjacent to each other, and a first pixel PX1 and a second pixel PX2 of the display panel 110, which are adjacent to each other in the first direction (e.g., the Y-axis direction). Referring to FIG. 3, the first pixel PX1 may be connected to the scan line SL, the first data line DL1, and a partial pressure reference line RL. The scan line SL may be bifurcated and transmit a scan signal to the first pixel PX1. The first data line DL1 may transmit a data voltage to the first pixel PX1. A predetermined reference voltage (or a predetermined partial reference voltage) may be applied to the partial pressure reference line RL.

The second pixel PX2 may be connected to the bifurcated scan line SL, the second data line DL2, and the partial pressure reference line RL. The scan line SL may transmit a scan signal to the second pixel PX2. The second data line DL2 may transmit a data voltage to the second pixel PX2. The reference voltage may be applied to the partial pressure reference line RL.

Each of the first pixel PX1 and the second pixel PX2 may include first subpixels SPX1 and second subpixels SPX2.

The first subpixel SPX1 may include a first switching element T1 and a first liquid crystal capacitor Ca, and the second subpixel SPX2 may include a second switching element T2, a second liquid crystal capacitor Cb, and a third switching element T3.

The first, second, and third switching elements T1, T2, and T3 may be thin-film transistors (TFTs).

The first switching element T1 may include a first electrode which is connected to the first or second data line DL1 or DL2, a second electrode which is connected to the first liquid crystal capacitor Ca, and a gate electrode which is connected to the scan line SL. A second electrode of the first switching element T1 may be connected to a first subpixel electrode that forms the first liquid crystal capacitor Ca.

The second switching element T2 may include a first electrode which is connected to the first or second data line DL1 or DL2, a second electrode which is connected to the second liquid crystal capacitor Cb, and a gate electrode which is connected to the scan line SL. A second electrode of the second switching element T2 may be connected to a second subpixel electrode that forms the second liquid crystal capacitor Cb.

The third switching element T3 may include a first electrode which is connected to the second liquid crystal capacitor Cb, a second electrode which is connected to the partial pressure reference line RL, and a gate electrode which is connected to the scan line SL. The reference voltage may be applied to a second electrode of the third switching element T3 via the partial pressure reference line RL.

The first electrodes of the first switching element T1, the second switching element T2, and the third switching element T3 may be source electrodes, and the second electrodes of the first switching element T1, the second switching element T2, and the third switching element T3 may be drain electrodes.

The first liquid crystal capacitor Ca and the second liquid crystal capacitor Cb may be connected to a common electrode, and a common voltage may be applied to the common electrode.

In response to a gate-on voltage being applied to the scan line SL, the first switching element T1, the second switching element T2, and the third switching element T3 may be turned on, and the first liquid crystal capacitor Ca and the second liquid crystal capacitor Cb may be charged with the data voltage transmitted thereto via the first data line DL1 or the second data line DL2. The data voltage applied to the first subpixel electrode may be the same as the data voltage applied to the second subpixel electrode, the first liquid crystal capacitor Ca may be charged in accordance with the difference between the common voltage and the data voltage, and the second liquid crystal capacitor Cb may be charged in accordance with the difference between the common voltage and a data voltage divided by the third switching element T3.

Since the third switching element T3 is connected in series to the second switching element T2 and is turned on, the data voltage transmitted to the second subpixel SPX2 may be divided by the second switching element T2 and the third switching element T3. For example, the data voltage may be divided in accordance with the channel sizes (or capacities) of the second switching element T2 and the third switching element T3. Thus, even if the same data voltage is transmitted to the first subpixel SPX1 and the second subpixel SPX2 via the first data line DL1 or the second data line DL2, the voltage that the first liquid crystal capacitor Ca is to charged with may differ from the voltage that the second liquid crystal capacitor Cb is charged with. For example, the voltage that the second liquid crystal capacitor Cb is charged with may be lower than the voltage that the first liquid crystal capacitor Ca is charged with. In this example, the side visibility of the display device 10 may be increased.

The reference voltage applied to the second electrode of the third switching element T3 may be the same as, or higher than, the common voltage applied to the common electrode. For example, the common voltage may be about 7 V, and the reference voltage applied to the second electrode of the third switching element T3 may be about 8 V to 11 V. However, the present invention is not limited thereto.

According to the exemplary embodiment of the present invention shown in FIG. 3, the first pixels PX1 and the second pixels PX2, which are adjacent to each other in the first direction (e.g., the Y-axis direction), are connected to the same scan line, but different data lines (e.g., the first data line DL1 and the second data line DL2), and can thus be charged with data voltages at the same time. Thus, the number of scan lines SL can be reduced, and the length, in the first direction (e.g., the Y-axis direction), of the pixels and the design areas of the first scan driver SD1 and the second scan drive SD2 can be widened.

Also, according to the exemplary embodiment of the present invention depicted in FIG. 3, since each pair of adjacent pixels in the first direction (e.g., the Y-axis direction) are allocated to different data lines, the number of data lines of the display panel 110 may be increased. However, the groups of data lines of each pair of adjacent data areas are electrically connected to first and second flexible films 122 and 124. Thus, the first pads PD1 on the upper side of the display panel 110 and the second pads PD2 on the lower side of the display panel 110 can be designed to be wider than the first data area DA1 through the twenty-fourth data area DA24, and as a result, the width of the first flexible films 122 and the width of the second flexible films 124 can be wider than the width of the first data area DA1 through the twenty-fourth data area DA24. Accordingly, the first flexible films 122 and the second flexible films 124 can be properly attached to the display panel 110.

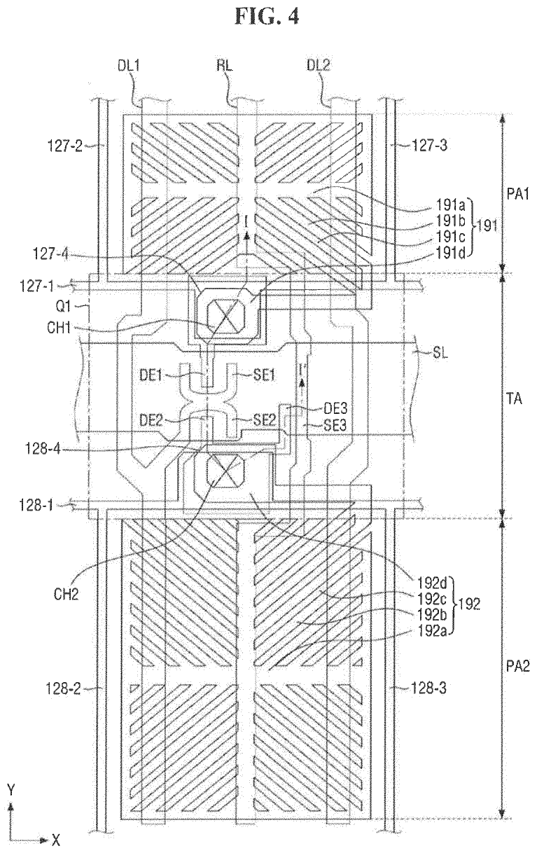

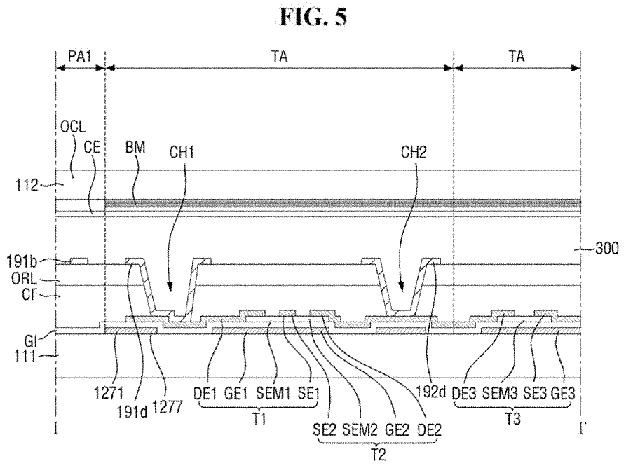

FIG. 4 is a plan view illustrating the first pixels PX1 and the second pixels PX2 in a first data area DA1 of FIG. 2. FIG. 5 is a cross-sectional view taken along line I-I′ of FIG. 4.

Referring to FIGS. 4 and 5, the first pixel PX1 may include a first subpixel area PA1, a second subpixel area PA2, and a switching element area TA. The first subpixel area PA1 may be defined as an area in which a first stem electrode 191a and first branch electrodes 191b of a first subpixel electrode 191 are disposed, and the second subpixel area PA2 may be defined as an area in which a second stem electrode 192a and second branch electrodes 192b of a second subpixel electrode 192 are disposed. The switching element area TA may be an area in which the first switching element T1, the second switching element T2, and the third switching element T3 of the first pixel PX1 are disposed. The switching element area TA may be disposed between the first subpixel area PA1 and the second subpixel area PA2 in the first direction (e.g., the Y-axis direction).

The first substrate 111 may be formed of an insulating material such as glass, quartz, and/or a polymer resin. Examples of the polymer resin include polyethersulphone (PES), polyacrylate (PA), polyarylate (PAR), polyetherimide (PEI), polyethylene naphthalate (PEN), polyethylene terephthalate (PET), polyphenylene sulfide (PPS), polyallylate, polyimide (P1), polycarbonate (PC), cellulose triacetate (CAT), cellulose acetate propionate (CAP), and/or a combination thereof. The first substrate 111 may also include a metallic material.

The expression “two elements are disposed in the same layer”, as used herein, may mean that the two elements share the same underlying layer or are disposed on the same level. Also, the expression “two elements are connected”, as used herein, may mean that the two elements are physically connected and/or are in physical contact with each other. Also, the expression “two elements are electrically connected”, as used herein, may mean that the two elements are physically connected, or are not connected physically, but are electrically connected via a conductor.

A first conductive layer may be disposed on the first substrate 111. The first conductive layer may include the scan line SL, a first gate electrode GE1, a second gate electrode GE2, and a third gate electrode GE3. The scan line SL, the first gate electrode GE1, the second gate electrode GE2, and the third gate electrode GE3 may be disposed in the same layer and may be formed of the same material. The scan line SL may extend in the second direction (e.g., the X-axis direction). The first gate electrode GE1, the second gate electrode GE2, and third gate electrode GE3 may be electrically connected to the scan line SL. The first gate electrode GE1, the second gate electrode GE2, and the third gate electrode GE3 may be connected to one another, but the present invention is not limited thereto. The first conductive layer may include at least one metal selected from among molybdenum (Mo), aluminum (Al), platinum (Pt), palladium (Pd), silver (Ag), magnesium (Mg), gold (Au), nickel (Ni), neodymium (Nd), iridium (Ir), chromium (Cr), titanium (T1), tantalum (Ta), tungsten (W), and copper (Cu). The first conductive layer may have a single-layer or multilayer structure.

A gate insulating layer GI may be disposed on the first conductive layer. The gate insulating layer GI may include an inorganic insulating material such as a silicon compound and/or a metal oxide. For example, the gate insulating layer GI may include silicon oxide, silicon nitride, silicon oxynitride, aluminum oxide, tantalum oxide, hafnium oxide, zirconium oxide, titanium oxide, or a combination thereof. The gate insulating layer GI may be a single-layer film or a multilayer film consisting of a stack of different materials.

A semiconductor layer may be disposed on the gate insulating layer GI. The semiconductor layer may include a semiconductor pattern having a first semiconductor area SEM1, a second semiconductor area SEM2, and a third semiconductor area SEM3.

The first semiconductor area SEM1I may overlap with the first gate electrode GE1. For example, the first semiconductor area SEM1 may be shorter than an underlying first gate electrode GE1 with the gate insulating layer GI disposed therebetween. The second semiconductor area SEM2 may overlap with the second gate electrode GE2. For example, the second semiconductor area SEM2 may be shorter than the underlying second gate electrode GE2 with the gate insulating layer GI disposed therebetween. The third semiconductor area SEM3 may overlap with the third gate electrode GE3. For example, the third semiconductor area SEM3 may be shorter than the underlying third gate electrode GE3 with the gate insulating layer GI disposed therebetween. The first semiconductor area SEM1, the second semiconductor area SEM2, and the third semiconductor area SEM3 may be areas (or channel areas) where channels are formed in response to an electric field being applied by the first gate electrode GE, the second gate electrode GE2, and the third gate electrode GE3 so that conductivity between respective pairs of source and drain electrodes can be inverted. The first semiconductor area SEM1, the second semiconductor area SEM2, and the third semiconductor area SEM3 may be formed as a single pattern.

According to an exemplary embodiment of the present invention, the semiconductor layer may include a silicon-based semiconductor material such as amorphous silicon, polycrystalline silicon, and/or monocrystalline silicon. However, the present invention is not limited thereto. For example, the semiconductor layer may include an oxide semiconductor. As another example, the semiconductor layer may include a binary compound (ABx), a ternary compound, and/or a quaternary compound (ABxCyDz) containing indium (In), zinc (Zn), gallium (Ga), tin (Sb), Ti, Al, hafnium (Hf), zirconium (Zr), and/or Mg. The semiconductor layer may also include indium tin zinc oxide (ITZO) and/or indium gallium zinc oxide (IGZO).

A second conductive layer may include the first data line DL1, the second data line DL2, a first source electrode SE1, a first drain electrode DE1, a second source electrode SE2, a second drain electrode DE2, a third source electrode SE3, a third drain electrode DE3, and the partial voltage reference line RL. The second conductive layer may be disposed on the gate insulating layer GI and on the semiconductor layer.

The first data line DL, the second data line DL2, the first source electrode SE1, the first drain electrode DE1, the second source electrode SE2, the second drain electrode DE2, the third source electrode SE3, the third drain electrode DE3, and the partial voltage reference line RL may be formed of the same material and may be disposed in the same layer.

The first data line DL1 and the second data line DL2 may extend substantially in the first direction (e.g., the Y-axis direction) and may be spaced apart from each other in the second direction (e.g., the X-axis direction). The first data line DL1 and the second data line DL2 may be disposed to overlap with the first subpixel electrode 191 and the second subpixel electrode 192, respectively, in a plan view. The first data line DL1 may be electrically connected to the first switching element T1 and the second switching element T2 of the first pixel PX1, and the second data line DL2 may be electrically connected to the first and second switching elements T1 and T2 of the second pixel PX2.

The reference voltage may be applied to the partial voltage reference line RL. As already mentioned above, the reference voltage applied to the partial voltage reference line RL may differ from the common voltage applied to a common electrode CE. For example, the reference voltage applied to the partial voltage reference line RL may be higher than the common voltage applied to the common electrode CE.

The partial voltage reference line RL may be disposed at least partially in parallel to the first data line DL1 and the second data line DL2. The partial voltage reference line RL may be disposed to overlap with the first subpixel electrode 191 and the second subpixel electrode 192 and may be located between the first data line DL1 and the second data line DL2 in a plan view.

The first data line DL1, the second data line DL2, and the partial voltage reference line RL may include portions that are disposed directly above, and in contact with, the gate insulating layer GI. The partial voltage reference line RL may intersect the semiconductor pattern.

The first source electrode SE1 may be electrically connected to the first data line DL1, may be disposed on the semiconductor pattern, and may overlap the first semiconductor area SEM1. For example, the first source electrode SE1 may be in contact with the first semiconductor area SEM1. The first source electrode SE1 may be connected to the second source electrode SE2 and may generally have a U shape. For example the first source electrode SE1 may have sides upturned in the first direction (e.g., the Y-axis direction) with the first drain electrode DE1 protruding therebetween.

The first drain electrode DE1 may be disposed on the first semiconductor area SEM1. For example, the first drain electrode DE1 may be at least partially in contact with the first semiconductor area SEM1. The first source electrode SE1 and the first drain electrode DE1 may be spaced apart from each other in the second direction (e.g., the X-axis direction).

The second source electrode SE2 may be electrically connected to the first data line DL1 and to the first source electrode SE1, for example, in the switching element area TA. The second source electrode SE2 may be disposed on, and in contact with, the second semiconductor area SEM2. The second source electrode SE2 may be connected to the first source electrode SE1 and may generally have a U shape. For example, the U shape of the second source electrode SE2 may be mirror symmetrical to the U shape of the first source electrode SE1, when viewed in a plan view.

The second drain electrode DE2 may be disposed on, and in contact with, the second semiconductor area SEM2. The second source electrode SE2 and the second drain electrode DE2 may be spaced apart from each other in the first direction (e.g., the Y-axis direction). For example, the second drain electrode DE2 may be shorter than the first drain electrode DE1 in the first direction (e.g., the Y-axis direction) and may be disposed between downturned sides of the U-shape of the second source electrode SE2.

The third source electrode SE3 may be electrically connected to the partial voltage reference line RL. For example, the third source electrode SE3 may bridge segments of the partial voltage reference line RL disposed in the first subpixel area PA1 and the second subpixel area PA2. The third source electrode SE3 may be disposed on the third semiconductor area SEM3. For example, the third source electrode SE3 may be in contact with the third semiconductor area SEM3. The third source electrode SE3 may be integrated with the partial voltage reference line RL.

The third drain electrode DE3 may be disposed on the third semiconductor area SEM3. For example, the third drain electrode DE3 may be in contact with the third semiconductor area SEM3. The third drain electrode DE3 may be substantially the same as the second drain electrode DE2 or may be integrated with the second drain electrode DE2. The third source electrode SE3 and the third drain electrode DE3 may be spaced apart from each other in the second direction (e.g., the X-axis direction). For example, the third source electrode SE3 may be disposed adjacent to the second data line DL2, and a space between the third source electrode SE3 and the third drain electrode DE3 may be less than a space between either of the first source electrode SE1 and the first drain electrode DE1 and the second source electrode SE2 and the second drain electrode DE2.

The second conductive layer may include at least one metal selected from among Mo, Al, Pt, Pd, Ag, Mg, Au, Ni, Nd, Ir, Cr, Ti, Ta, W, and Cu. The second conductive layer may be a single-layer film or a multilayer film. For example, the second conductive layer may be formed as a stack of Ti/Al/Ti, Mo/Al/Mo, Mo/AlGe/Mo, and/or Ti/Cu.

The first gate electrode GE1, the first semiconductor area SEM1, the first source electrode SE1, and the first drain electrode DE1 may form the first switching element T1, which is a TFT. The second gate electrode GE2, the second semiconductor area SEM2, the second source electrode SE2, and the second drain electrode DE2 may form the second switching element T2, which is a TFT. The third gate electrode GE3, the third semiconductor area SEM3, the third source electrode SE3, and the third drain electrode DE3 may form the third switching element T3, which is a TFT.

An organic layer ORL may be disposed on the second conductive layer. The organic layer ORL may have excellent planarization characteristics and may include a material having photosensitivity. A color filter CF may be disposed between the second conductive layer and the organic layer ORL. The color filter CF may have one of red, green, and blue colors, but the present invention is not limited thereto.

A first contact hole CH1 and a second contact hole CH2 which partially expose the first drain electrode DE1 and the second drain electrode DE2, respectively, may be formed in the color filter CF and the organic layer ORL. For example, the first contact hole CH1 and the second contact hole CH2 may contact an upper surface of the first drain electrode DE1 and the second drain electrode DE2, respectively, in a cross-sectional view.

A third conductive layer may be disposed on the organic layer ORL. The third conductive layer may include the first subpixel electrode 191 and the second subpixel electrode 192.

The first subpixel electrode 191 may be disposed in the first subpixel area PA1, and the second subpixel electrode 191 may be disposed in the second subpixel area PA2.

The first subpixel electrode 191 may be electrically connected to the first drain electrode DE1 via the first contact hole CH1. The first subpixel electrode 191 may overlap with the first drain electrode DE1. The second subpixel electrode 192 may be electrically connected to the second drain electrode DE2 via the second contact hole CH2 and may be in contact with the second drain electrode DE2.

The first subpixel electrode 191 may include the first stem electrode 191a, which is disposed in the first subpixel area PA1, a plurality of first branch electrodes 191b, which are disposed in the first subpixel area PA, extend outwardly from the first stem electrode 191a, and are spaced apart from one another by slits 191c, and a first extension 191d which extends from the first subpixel area PA1 into the switching element area TA.

The first stem electrode 191a may include a horizontal stem which extends in the second direction (e.g., the X-axis direction) and a vertical stem which generally extends in the first direction (e.g., the Y-axis direction), and may divide a pixel electrode into sub-areas, also referred to herein as domains. The first stem electrode 191a may be formed as a cross. In this case, the first subpixel electrode 191 may be divided into four sub-areas by the first stem electrode 191a. The first branch electrodes 191b may extend in different directions in different sub-areas. For example, as illustrated in FIG. 4, the first branch electrodes 191b may extend from the first stem electrode 191a in an upper right direction in an upper right sub-area, in a lower right direction in a lower right sub-area, in an upper left direction in an upper left sub-area, and in a lower left direction in a lower left sub-area.

The first extension 191d may extend from the first stem electrode 191a or the first branch electrodes 191b into the switching element area TA and may be connected to the first drain electrode DE1 via the first contact hole CH1. For example, the first extension 191d may include a portion that envelops a perimeter of the first contact hole CH1, when viewed in a plan view.

The second subpixel electrode 192 may include the second stem electrode 192a, which is disposed in the second subpixel area PA2, a plurality of second branch electrodes 192b, which are disposed in the second subpixel area PA2, extend outwardly from the second stem electrode 192a, and are spaced apart from one another by slits 192c, and a second extension 192d which extends from the second subpixel area PA2 into the switching element area TA.

The second stem electrode 192a, the second branch electrodes 192b, and the second extension 192d are substantially the same as, or similar to, the first stem electrode 191a, the first branch electrodes 191b, and the first extension 191d, and thus, detailed descriptions thereof will be omitted.

The third conductive layer may be formed of a transparent conductive oxide.

The first conductive layer may further include first sustain line 127 and second sustain line 128. A sustain voltage may be applied to the first sustain line 127 and the second sustain line 128. The sustain voltage may be the same as the common voltage applied to the common electrode CE, but the present invention is not limited thereto. For example, the sustain voltage may differ from the reference voltage applied to the partial voltage reference line RL.

The first sustain line 127 and the second sustain line 128 may be formed of the same material, and disposed in the same layer, as the scan line SL.

The first sustain line 127 may include a first portion 127-1 which extends substantially in the same direction as the scan line SL, i.e., in the second direction (e.g., the X-axis direction), a second portion 127-2 which extends from the first portion 127-1 in the first direction (e.g., the Y-axis direction) and is adjacent to one side of the first subpixel electrode 191, a third portion 127-3 extends from the first portion 127-1 in the first direction (e.g., the Y-axis direction) and is adjacent to the other side of the first subpixel electrode 191, and a fourth portion 127-4 protrudes from the first portion 127-1 and overlaps the first contact hole CH1.

The second portion 127-2 and the third portion 127-3 may not overlap with the first subpixel electrode 191. The second portion 127-2 and the third portion 127-3 may serve as light-shielding patterns capable of blocking the transmission of light on both sides of the first subpixel electrodes 191.

The fourth portion 127-4 may overlap with an expanded portion DE11 of the first drain electrode DE1 and may form sustain capacitance in the first subpixel area PA1.

The second sustain line 128 may include a first portion 128-1 which extends substantially in the same direction as the scan line SL, i.e., in the second direction (e.g. the X-axis direction), a second portion 128-2 which extends from the first portion 128-1 in the first direction (e.g., the Y-axis direction) and is adjacent to one side of the second subpixel electrode 192 (e.g., the left side of the second subpixel electrode 192), a third portion 128-3 extends from the first portion 128-1 in the second direction (e.g., the X-axis direction) and is adjacent to the other side of the second subpixel electrode 192 (e.g., the right side of the second subpixel electrode 192), and a fourth portion 128-4 protrudes from the first portion 128-1. The second portion 128-2 and third portion 128-3 may not overlap with the second subpixel electrode 192. The second portion 128-2 and the third portion 128-3 may serve as light-shielding patterns capable of blocking the transmission of light on both sides of the second subpixel electrodes 192.

The fourth portion 128-4 may partially overlap with the second subpixel electrode 192 and may form sustain capacitance in the second subpixel area PA2.

The third conductive layer may further include shielding electrodes. The shielding electrodes may be disposed in the same layer as one another, and formed of the same material as the first subpixel electrode 191 and the second subpixel electrode 192.

A light-shielding member BM, an overcoat layer OCL, and the common electrode CE may be disposed on the second substrate 112. However, the overcoat layer OCL may be omitted in an exemplary embodiment of the present invention.

The second substrate 112, like the first substrate 111, may be an insulating substrate. The second substrate 112 may include a polymer and/or plastic having heat resistance. The second substrate 112 may have flexibility.

The light-shielding member BM may be disposed on a first surface of the second substrate 112 that faces the first substrate 111. The light-shielding member BM may overlap with the switching element area TA. The light-shielding member BM may include a light-shielding pigment, such as black carbon and/or an opaque material such as Cr, or may include a photosensitive organic material, but the present invention is not limited thereto. For example, the light-shielding member BM may be disposed on the first substrate 111.

The overcoat layer OCL may be formed on the first surface of the second substrate 112 and may cover the light-shielding member BM. The overcoat layer OCL may planarize height differences generated by the light-shielding member BM.

The common electrode CE may be disposed on the overcoat layer OCL. In a case where the overcoat layer OCL is not provided, the common electrode CE may be disposed on the second substrate 112 and on the light-shielding member BM. The common electrode CE may be formed of a transparent conductive material such as ITO and/or IZO. The common electrode CE may be formed on the entire surface of the second substrate 112. The common voltage may be applied to the common electrode CE, and the common electrode CE may form an electric field together with the first subpixel electrode 191 and the second subpixel electrode 192. In this case, the alignment of liquid crystal molecules in a liquid crystal layer 300 may vary depending on the intensity of the electric field, and as a result, the transmittance of light may be controlled.

The liquid crystal layer 300 may include liquid crystal molecules having dielectric anisotropy. In response to an electric field being applied between the first and second substrates 111 and 112, the liquid crystal molecules may rotate in a particular direction between the first and second substrates 111 and 112, and as a result, the phase delay of light passing through the liquid crystal layer 300 may be adjusted. The amount of polarized light (e.g., light transmitted through a lower polarizer member) passing through an upper polarizer member (disposed on an emission side, e.g., on the outer surface of the second substrate 112) may vary depending on the degree to which the phase delay of light passing through the liquid crystal layer 300 is changed by the rotation of the liquid crystal molecules. In this manner, the transmittance of light can be controlled.

FIG. 6 illustrates the first scan driver of the display panel of FIG. 2 according to an exemplary embodiment of the present invention.

Referring to FIG. 6, the first scan driver SD1 includes a first start signal line STL1 to which a first start signal is applied and a plurality of clock lines CLS to which a plurality of clock signals are applied. The first start signal and the clock signals may correspond to the first scan control signals provided via the first scan control lines SCLS1.

The first scan driver SD1 may include a plurality of first through n-th stages ST1 through STn which are connected to a plurality of first through n-th scan lines S1 through Sn, respectively. For convenience of illustration, FIG. 5 illustrates only the first stage ST1 through the fourth stage ST4 and the (n−3)-th stage STn−3 through the n-th stage STn.

The term “previous stage(s)”, as used herein, refers to the stage(s) previous to each given stage, and the term “subsequent stage(s)”, as used herein, refers to the stage(s) subsequent to each given stage. For example, the previous stages of the third stage ST3 may be the first stage ST1 and the second stage ST2, and the subsequent stages of the third stage ST3 may be the fourth stages ST4 through the n-th stage STn.

Each of the first stage ST1 through n-th stage STn includes a start terminal ST, a subsequent-stage carry signal input terminal NT, at least one clock terminal CT, and an output terminal OT.

The start terminal ST may be connected to the first start signal line STL1 or the output terminal OT of a previous stage. The first start signal from the first start signal line STL1 or the output signal of the output terminal OT of the previous stage may be input to the start terminal ST. FIG. 6 illustrates the start terminals ST of the first stage ST1 through n-th stage STn as being connected to the output terminals OT of their respective second previous stages, but the present invention is not limited thereto.

The subsequent-stage carry signal input terminal NT may be connected to the output terminal OT of a subsequent stage. The subsequent-stage carry signal input terminal NT may receive an output signal of the output terminal OT of a subsequent stage. FIG. 6 illustrates the subsequent-stage carry signal input terminals NT of the first stage ST1 through n-th stage STn as receiving the output signals of their respective third subsequent stages, but the present invention is not limited thereto.

Each of the clock terminals CT of the first stage ST1 through n-th stage STn may be connected to one of the clock lines CLS. Clock signals which are sequentially phase-delayed may be applied to the clock signals CLS. The clock signals may swing between a gate-off voltage and a gate-on voltage.

The clock signals CLS may be alternately connected to the clock terminals CT of the stage first stage ST1 through the n-th stage STn. For example, the clock terminal CT of the first stage ST1 may be connected to a first clock line to which a first clock signal is applied, the clock terminal CT of the second stage ST2 may be connected to a second clock line CL2 to which a second clock signal is applied, and the clock terminal CT of the third stage ST3 may be connected to a third clock line to which a third clock signal is applied.

The output terminals OT of the first stage ST1 through n-th stage STn may be connected to the first scan line S1 through the n-th scan line Sn and may output scan signals.

According to the exemplary embodiment of the present invention illustrated in FIG. 6, since a start signal is applied to the first stage ST1, the first stage ST1 through the n-th stage STn can sequentially output scan signals.

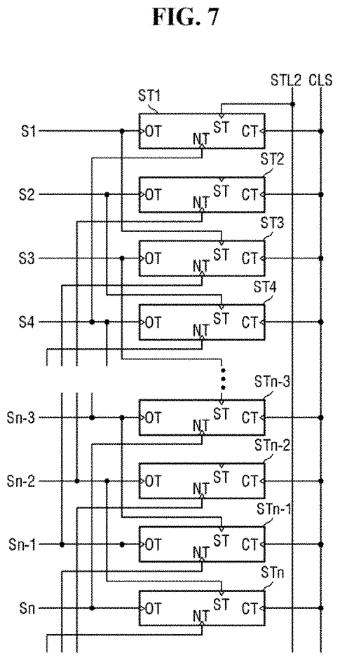

The second scan driver SD2 of FIG. 7 is substantially the same as the first scan driver SD1 of FIG. 6, and thus, a detailed description thereof will be omitted. However, the second scan driver SD2 receives a second start signal through the second start signal line STL2.

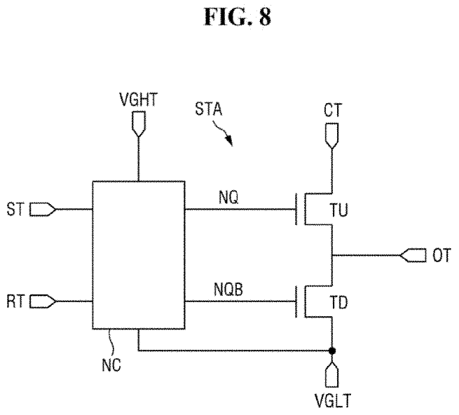

FIG. 8 illustrates a stage of FIG. 6 according to an exemplary embodiment of the present invention.

Referring to FIG. 8, a stage STA includes a pull-up node NQ, a pull-down node NQB, a pull-up transistor TU which is turned on in response to the pull-up node NQ having the gate-on voltage, a pull-down transistor TD which is turned on in response to the pull-down node NQB having the gate-on voltage, and a node controller NC which controls the charge/discharge of the pull-up node NQ and the pull-down node NQB.

The node controller NC may be connected to a start terminal ST to which a start signal or an output signal of a previous stage is applied, to a reset terminal RT to which an output signal of a subsequent stage is input, and to a gate-off voltage terminal VGLT to which the gate-off as voltage is applied. FIG. 8 illustrates the stage STA as having a single gate-off voltage terminal VSST, but the present invention is not limited thereto. Alternatively, the stage STA may include two gate-off voltage terminals VGLT.

The node controller NC controls the charge/discharge of the pull-up node NQ and the pull-down node NQB in accordance with the start signal or the output signal of the previous stage, input to the start terminal ST. In order to stably control the output of the stage STA, the node controller NC controls the pull-down node NQB to have the gate-off voltage when the pull-up node NQ has the gate-on voltage, and controls the pull-up node NQ to have the gate-off voltage when the pull-down node NQB has the gate-on voltage. To this end, the node controller NC may include a plurality of transistors.

When the pull-up node NQ is being pulled up, e.g., the pull-up node NQ has the gate-on voltage, the pull-up transistor TU is turned on to output a clock signal input to a clock terminal CT to an output terminal OT. When the pull-up node NQ is being pulled-down, e.g., when the pull-up node NQ has the gate-on voltage, the pull-down transistor TD is turned on to output the gate-off voltage at the gate-off voltage terminal VGLT to the output terminal OT.

The pull-up transistor TU, the pull-down transistor TD, and the transistors of the node controller NC may all be formed as TFTs.

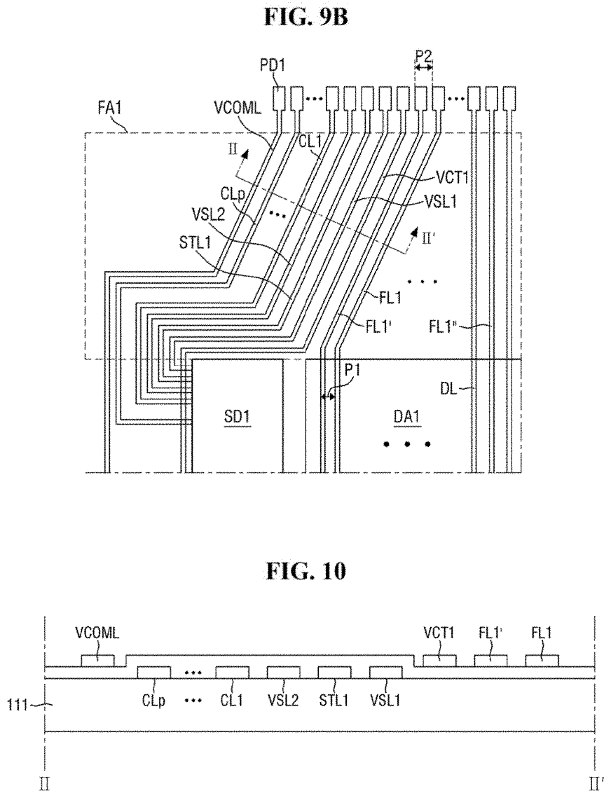

FIG. 9A is a plan view illustrating a first fan-out area FA1 of FIG. 2. FIG. 10 is a cross-sectional view taken along line II-II′ of FIG. 9A.

Referring to FIG. 9A, first pads PD1 may be disposed at an upper end of the display panel 110. The first pads PD1 may be connected to first fan-out lines FL1, a first sustain voltage line VCT1, the first scan control lines SCLS1, and a common voltage line VCOML. The first pads PD1 may be spaced in the second direction (e.g., the X-axis direction). According to an exemplary embodiment of the present invention, the first pads PD1 may be formed in a staggered arrangement.

Referring to FIG. 10, the first scan control lines SCLS1 may be formed in the same first conductive layer as the scan line SL, the first gate electrode GE1, the second gate electrode GE2, and the third gate electrode GE3 of FIG. 3. Also, referring to FIG. 10, the first fan-out lines FL1, the first sustain voltage line VCT1, and the common voltage line VCOML may be formed of the same second conductive layer as the first data line DL1, the second data line DL2, the first source electrode SE1, the first drain electrode DE1, the second source electrode SE2, the second drain electrode DE2, the third source electrode SE3, the third drain electrode DE3, and the partial pressure reference line RL of FIG. 3.

The first fan-out lines FL1 may be connected to the data lines DL in the first data area DA1. The first fan-out lines FL1 may become shorter in a direction from the left side or the right side to the center of the first data area DA1. For example, first fan-out lines FL1 disposed at the left side or the right side of the first data area DA1 may extend diagonally in relation to associated data lines DL while centermost first fan-out lines FL1 extend in parallel to associated data lines DL.

For convenience, first fan-out lines FL1 disposed on the left side or the right side of the first data area DA1 will hereinafter be referred to as first fan-out lines FL1′, an enlarged view of which is depicted with reference to FIG. 1. First fan-out lines FL1 disposed at the center of the first data area DA1 will hereinafter be referred to as first fan-out lines FL″. The smaller the differences between the lengths of the first fan-out lines FL1′ and the lengths of the first fan-out lines FL1″, the smaller the length, in the first direction (e.g., the Y-axis direction), of the first fan-out area FA1 may be. As illustrated in FIG. 2, the smaller the difference between the width of the first flexible films 122 and the width of the first data areas DA1 through twenty-fourth data area DA24, the smaller the differences between the lengths of the first fan-out lines FL1′ and the lengths of the first fan-out lines FL1″.

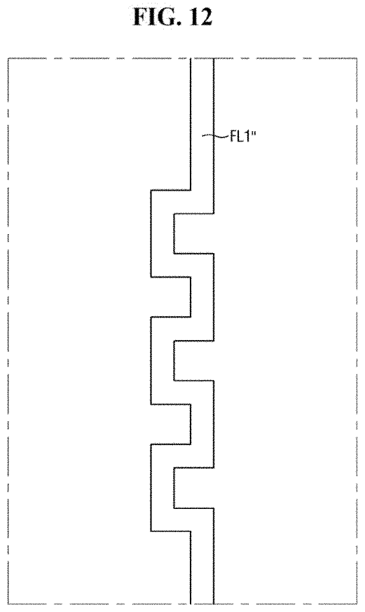

If the differences between the lengths of the first fan-out lines FL1′ and the lengths of the first fan-out lines FL1″ are too large, the differences between the resistances of the first fan-out lines FL1′ and the resistances of the first fan-out lines FL1″ may also be too large. In order to minimize the differences between the resistances of the first fan-out lines FL1′ and the resistances of the first fan-out lines FL1″, the first fan-out lines FL1′ may be formed to be straight, and the first fan-out lines FL1″ may be formed to be winding, as illustrated in FIG. 12.

The first scan control lines SCLS1 may include a first gate-off signal line VSL1, the first start signal line STL1, a second gate-off signal line VSL2, and a plurality of first clock signal lines CL1 through CL1p (where p is an integer of 2 or greater). For example, each of the first scan control lines SCLS1 may have a first segment diagonally extend from corresponding pads PD1, a second segment extending substantially in the second direction (e.g., the X-axis direction) from the first segment, and a third L-shaped segment extending from the second segment that attaches to an outer side (e.g., the left side) of the first scan driver SD1.

The first sustain voltage line VCT1 may be disposed between the first gate-off signal line VSL1 and the first scan driver SD1. For example, the first sustain voltage line VCT1 may cover two surfaces of the first scan driver SD1 and may orthogonally intersect a connection region between the remaining first scan control lines SCLS1. The first sustain voltage line VCT1 may be connected to the first sustain line 127 and the second sustain line 128 of FIG. 5.

The common voltage line VCOML may be disposed on the left side of the array of the first clock signal lines CL1 through CL1p. The common voltage may be applied to the common voltage line VCOML.

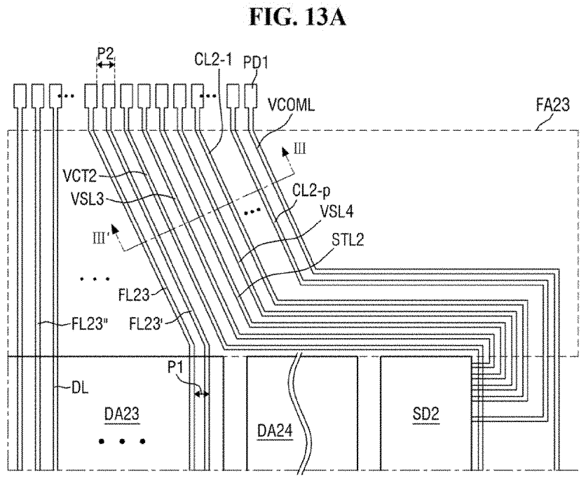

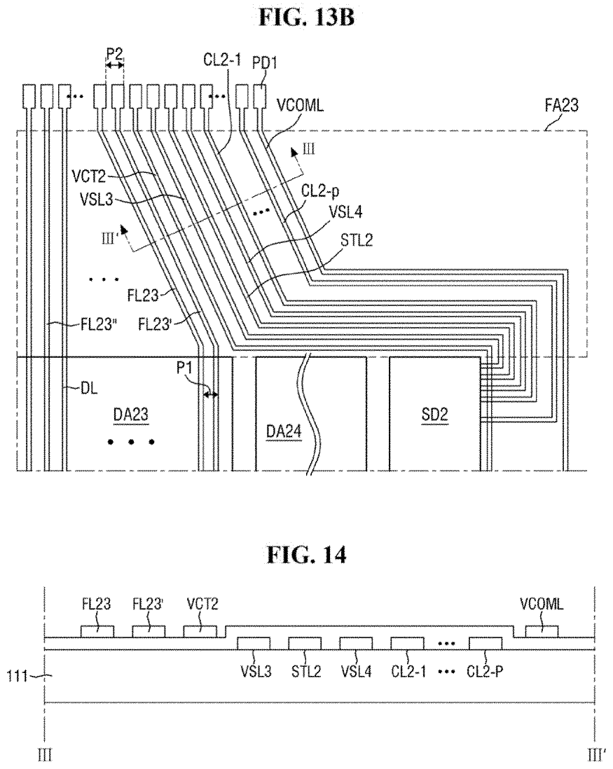

FIG. 13A is a plan view illustrating a twenty-third fan-out area FA23 of FIG. 2. FIG. 14 is a cross-sectional view taken along line III-III′ of FIG. 13A.

Referring to FIGS. 13 and 14, first pads PD1 may be disposed at the upper end of the display panel 110. The first pads PD1 may be connected to twenty-third fan-out lines FL23, a second sustain voltage line VCT2, the second scan control lines SCLS2, and the common voltage line VCOML.

Referring to FIG. 14, the second scan control lines SCLS2 may be formed in the same first conductive layer as the scan line SL, the first gate electrode GE1, the second gate electrode GE2, and the third gate electrode GE3 of FIG. 3. Also, referring to FIG. 14, the twenty-third fan-out lines FL23, the second sustain voltage line VCT2, and the common voltage line VCOML may be formed in the same second conductive layer as the first data line DLL, the second data line DL2, the first source electrode SE1, the first drain electrode DE1, the second source electrode SE2, the second drain electrode DE2, the third source electrode SE3, the third drain electrode DE3, and the partial pressure reference line RL of FIG. 3.

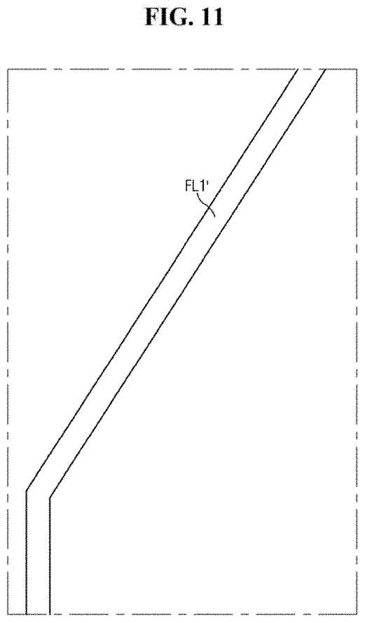

The twenty-third fan-out lines FL23 may be connected to the data lines in the twenty-third data area DA23. The twenty-third fan-out lines FL23 are substantially the same as the first fan-out lines FL1 of FIGS. 9 through 12, and thus, a detailed description thereof will be omitted for brevity.

The second scan control lines SCLS2 may include a third gate-off signal line VSL3, a second start signal line STL2, a fourth gate-off signal line VSL4, and a plurality of second clock signal lines CL2-1 through CL2-p.

The second sustain voltage line VCT2 may be disposed between the third gate-off signal line VSL3 and the second scan driver SD2. The second sustain voltage line VCT2 may be connected to the first sustain line 127 and the second sustain line 128 of FIG. 5.

The common voltage line VCOML may be disposed on the right side of the array of the second clock signal lines CL2-1 through CL2-p. The common voltage may be applied to the common voltage line VCOML.

Since the twenty-fourth data area DA24 is disposed between the second scan driver SD2 and the twenty-third data area DA23, as illustrated in FIG. 13A, the second scan control lines SCLS2 may be connected to the first pads PD in the twenty-third fan-out area FA23 while overlapping an upper side of the twenty-fourth data area DA24. In contrast, the first scan driver SD1 and the first data area DA1 may be adjacent to each other, as illustrated in FIG. 9A. Thus, the lengths of the second scan control lines SCLS2 may be greater than the lengths of the first scan control lines SCLS1.

Referring again to FIG. 2, the second flexible film 124-1 may include first dummy lead pads which are connected to first dummy pads disposed on the lower side of the display panel 110. The number of first dummy pads of the display panel 110 that are connected to the first dummy lead pads of the second flexible film 124-1 may be the same as the number of first pads PD1 in the first flexible film 122-1 that are connected to the first scan control lines SCLS1.

Also, the second flexible film 124-12 may include second dummy lead pads which are connected to second dummy pads disposed on the lower side of the display panel 110. The number of second dummy pads of the display panel 110 that are connected to the second dummy lead pads of the second flexible film 124-12 may be the same as the number of first pads PD1 in the second flexible film 124-12 that are connected to the second scan control lines SCLS2.

Due to the presence of the first pads PD1 connected to the first scan control lines SCLS1, the second pads PD2 connected to the second scan control lines SCLS2, the first dummy pads, and the second dummy pads, the numbers of data lines in the first, second, twenty-third, and twenty-fourth data areas DA1, DA2, DA23, and DA24 may all be the same. Also, the third through twenty-second data areas DA3 through DA22 may have the same number of data lines. The number of data lines in each of the first, second, twenty-third, and twenty-fourth data areas DA1, DA2, DA23, and DA24 may be smaller than the number of data lines in each of the third through twenty-second data areas DA3 through DA22.

FIG. 9B is a plan view illustrating a second fan-out area of FIG. 2. FIG. 13B is a plan view illustrating a twenty-fourth fan-out area of FIG. 2.

The embodiment of FIG. 9B differs from the embodiment of FIG. 9A in that second pads PD2 are connected to the twenty-fourth fan out lines FL24 and first dummy pads DPD1 exist instead of the first pads PD1 connected to the first scan lines SCLS1 including the first gate-off signal line VSL1, the first start signal line STL1, the second gate-off signal line VSL2, and the plurality of first clock signal lines CL1 through CL1p. A detailed description of the embodiment of FIG. 9B will be omitted.

The embodiment of FIG. 13B differs from the embodiment of FIG. 13A in that second pads PD2 are connected to the second fan out lines FL2 and second dummy pads DPD2 exist instead of the first pads PD1 connected to the second scan lines SCLS2 including the third gate-off signal line VSL3, the second start signal line STL2, the fourth gate-off signal line VSL4, and the plurality of second clock signal lines CL2-1 through CL2-p. A detailed description of the embodiment of FIG. 13B will be omitted.

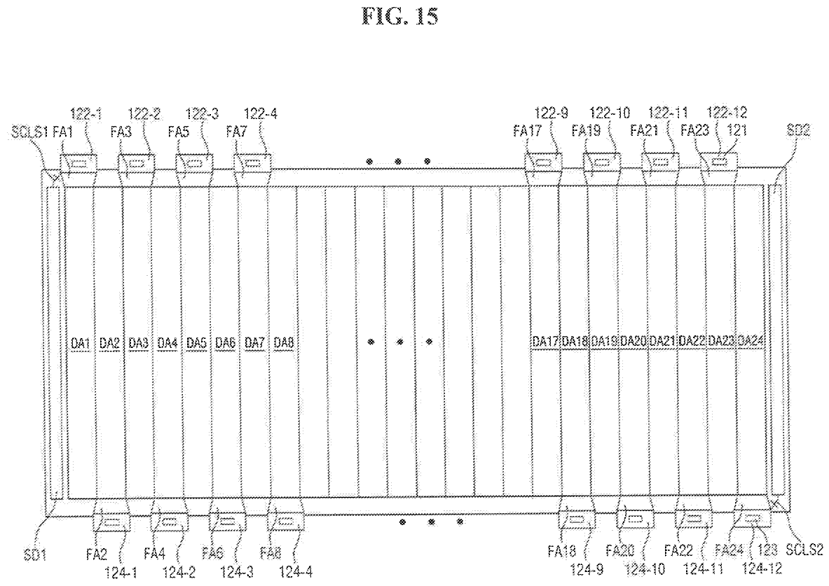

FIG. 15 is a plan view illustrating a display panel, first flexible films and second flexible films of FIG. 1 according to an exemplary embodiment of the present invention.

The exemplary embodiment of FIG. 15 differs from the exemplary embodiment of FIG. 2 in that second scan control lines SCLS2 are electrically connected to a second scan driver SD2 and a second flexible film 124-12. For example, in the exemplary embodiment of the present invention according to FIG. 15, the second scan control lines SCLS2 may be disposed at a right opposite corner of the display panel 110 from the first scan control lines SCLS1 and connect to an outermost second flexible film 124-12 attached to an outermost data area DA24. A detailed description of the previously described elements of the exemplary embodiment of FIG. 15 will be omitted for brevity.

FIG. 16 is a plan view illustrating a twenty-fourth fan-out area of FIG. 15.

Referring to FIG. 16, second pads PD2 may be disposed at a lower end of the display panel 110. The second pads PD2 may be connected to twenty-fourth fan-out lines FL24, the second sustain voltage line VCT2, the second scan control lines SCLS2, and the common voltage line VCOML.

As already mentioned above with reference to FIG. 14, the second scan control lines SCLS2 may be formed in the same first conductive layer as the scan line SL, the first gate electrode GE1, the second gate electrode GE2, and the third gate electrode GE3 of FIG. 3. Also, as already mentioned above with reference to FIG. 14, the twenty-fourth fan-out lines FL24, the second sustain voltage line VCT2, and the common voltage line VCOML may be formed in the same second conductive layer as the first data line DL1, the second data line DL2, the first source electrode SE1, the first drain electrode DE1, the second source electrode SE2, the second drain electrode DE2, the third source electrode SE3, the third drain electrode DE3, and the partial pressure reference line RL of FIG. 3.

The twenty-fourth fan-out lines FL24 may be connected to the data lines DL in the twenty-fourth data area DA24. The twenty-fourth fan-out lines FL24 are substantially the same as the first fan-out lines FL1 of FIGS. 9 through 12, and thus, a detailed description thereof will be omitted for brevity.

The second scan control lines SCLS2 may include the third gate-off signal line VSL3, the second start signal line STL2, the fourth gate-off signal line VSL4, and the second clock signal lines CL2-1 through CL2-p.

The second sustain voltage line VCT2 may be disposed between the third gate-off signal line VSL3 and the second scan driver SD2. The second sustain voltage line VCT2 may be connected to the first sustain line 127 and the second sustain line 128 of FIG. 5.

The common voltage line VCOML may be disposed on the right side of the array of the second clock signal lines CL2-1 through CL2-p. The common voltage may be applied to the common voltage line VCOML.

As illustrated in FIG. 16, The second scan driver SD2 and the twenty-fourth data area DA24 may be adjacent to each other, and the first scan driver SD1 and the first data area DA1 may be adjacent to each other. Thus, the lengths of the second scan control lines SCLS2 may be substantially the same as the lengths of the first scan control lines SCLS1.

Meanwhile, referring to FIG. 15, the second flexible film 124-1 may include the first dummy lead pads which are connected to the first dummy pads disposed on the lower side of the display panel 110. The number of first dummy pads of the display panel 110 that are connected to the first dummy lead pads of the second flexible film 124-1 may be the same as the number of first pads PD1 in the first flexible film 122-1 that are connected to the first scan control lines SCLS1.

Also, the first flexible film 122-12 may include second dummy lead pads which are connected to second dummy pads disposed on the upper side of the display panel 110. The number of second dummy pads of the display panel 110 that are connected to the second dummy lead pads of the first flexible film 122-12 may be the same as the number of second pads PD2 in the second flexible film 124-12 that are connected to the second scan control lines SCLS2.

Due to the presence of the first pads PD1 connected to the first scan control lines SCLS1, the second pads PD2 connected to the second scan control lines SCLS2, the first dummy pads, and the second dummy pads, the numbers of data lines in the first, second, twenty-third, and twenty-fourth data areas DA1, DA2, DA23, and DA24 may all be the same. Also, the third through twenty-second data areas DA3 through DA22 may have the same number of data lines. The number of data lines in each of the first, second, twenty-third, and twenty-fourth data areas DA1, DA2, DA23, and DA24 may be smaller than the number of data lines in each of the third through twenty-second data areas DA3 through DA22.

The first scan driver SD1 and the second scan driver SD2 of FIG. 15 are substantially the same as described above with reference to FIGS. 6 and 7. Since the start signal is applied to the first stage ST1, the first through n-th stages ST1 through STn can sequentially output scan signals even though the second scan driver SD2 is connected to the second scan control lines SCLS2 at the lower side of the display panel 110.

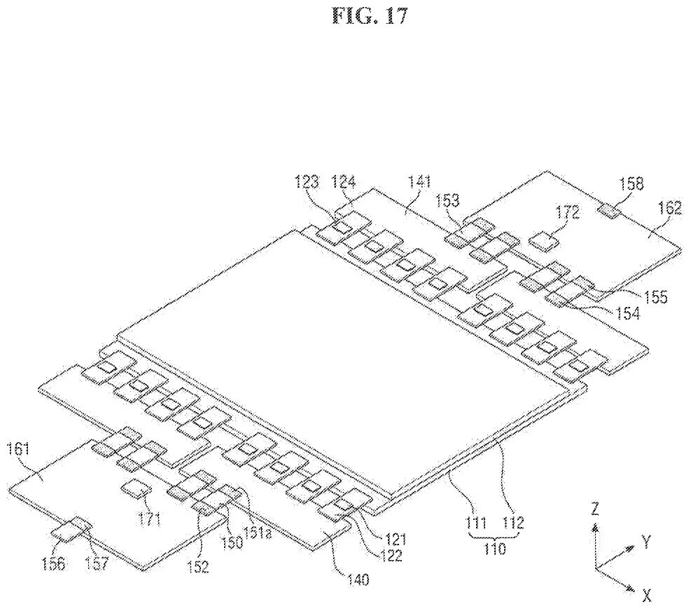

FIG. 17 is a perspective view of a display device according to an exemplary embodiment of the present invention.

The exemplary embodiment of FIG. 17 differs from the exemplary embodiment of FIG. 1 in that a first control circuit board 161 on which first timing control circuits 171 are disposed is connected to a first source circuit board 140 via first cables 150, and that a second control circuit board 162 on which second timing control circuits 172 are disposed is connected to a second source circuit board 141 via second cables 153. The embodiment of FIG. 17 will hereinafter be described, focusing mainly on the differences from the exemplary embodiment of FIG. 1.

Referring to FIG. 17, the first source driving circuits 121 convert first digital video data into analog data voltages in accordance with a first source control signal from the first timing control circuit 171 and output the analog data voltages to data lines of a display panel 110 via first flexible films 122. The second source driving circuits 123 convert second digital video data into analog data voltages in accordance with a second source control signal from the second timing control circuit 172 and output the analog data voltages to the data lines of the display panel 110 via second flexible films 124.

The first source circuit boards 140 may be connected to the first control circuit board 161 via the first cables 150. The second source circuit boards 141 may be connected to the second control circuit board 162 via the second cables 153.

The first control circuit board 161 may be connected to the first source circuit boards 140 via the first cables 150. The first control circuit board 161 may include second connectors 152 which are connected to the first cables 150.

The second control circuit board 162 may be connected to the second source circuit boards 141 via the second cables 153. The second control circuit board 162 may include fourth connectors 155 which are connected to the second cables 153.

The first control circuit board 161 and the second control circuit board 162 may be PCBs or FPCBs.

FIG. 17 illustrates that four first cables 150 are provided to connect the first source circuit boards 140 and the first control circuit board 161, and that four second cables 153 are provided to connect the second source circuit boards 141 and the second control circuit board 162, but the numbers of first cables 150 and second cables 153 are not particularly limited.

The first timing control circuit 171 may be disposed on the first control circuit board 161. The first timing control circuit 171 may be formed as an IC. The first timing control circuit 171 may receive the first digital video data and first timing signals from a system-on-chip of a system circuit board. The first timing control circuit 171 may generate the first source control signal, which is for controlling the timings of the first source driving circuits 121, in accordance with the first timing signals.

The second timing control circuit 172 may be disposed on the second control circuit board 162. The second timing control circuit 172 may be formed as an IC. The second timing control circuit 172 may receive the second digital video data and second timing signals from the system-on-chip of the system circuit board. The second timing control circuit 172 may generate the second source control signal, which is for controlling the timings of the second source driving circuits 123, in accordance with the second timing signals.

In a case where first scan driver SD1 and the second scan driver SD2 receive first scan control signals via the first flexible films 122, as illustrated in FIG. 3, the first timing control circuit 171 may generate the first scan control signals, which are for controlling the timing of the first scan driver SD1, in accordance with the first timing signals.

In a case where the first scan driver SD1 receives the first scan control signals via the first flexible films 122 and the second scan driver SD2 receives the second scan control signals via the second flexible films 124, as illustrated in FIG. 15, the first timing control circuit 171 may generate the first scan control signals, which are for controlling the timing of the first scan driver SD1, in accordance with the first timing signals, and the second timing control circuit 172 may generate the second scan control signals, which are for controlling the timing of the second scan driver SD2, in accordance with the second timing signals.

The first control circuit board 161 and the second control circuit board 162 may be connected to each other via a third cable 156. The first control circuit board 161 may include a fifth connector 157 which is connected to the third cable 156, and the second control circuit board 162 may include a sixth connector 158 which is connected to the third cable 156. For example, in the case where the first flexible films 122 and the second flexible films 124 are bent such that the first control circuit board 161 and the second control circuit board 162 are disposed under the second substrate 112, the first control circuit board 161 and the second control circuit board 162 may be connected by the third cable 156.

The first and second timing control circuits 171 and 172 may transmit timing s15 synchronization signals for timing synchronization via the third cable 156.

According to the aforementioned and other exemplary embodiments of the present invention, the first flexible films are disposed on the first side of the display panel, and the second flexible films are disposed on the second side of the display panel. Data lines in one of a pair of adjacent data areas are electrically connected to a first flexible film, and data lines in the other data area are electrically connected to a second flexible film. Accordingly, first pads disposed on the upper side of the display panel and second pads disposed on the lower side of the display panel can be made to be wider than the data areas of the display area. Therefore, the first flexible films and the second flexible films on the display panel can be properly attached without any short circuits, for example.

In addition, since first and second pixels that are adjacent to each other in the first direction are connected to different data lines, the first and second pixels are connected to the same scan line, but can be charged with data voltages at the same time. Thus, the number of scan lines can be reduced, and as a result, the length, in the first direction, of each pixel and the areas of the first and second scan drivers can be widened.

While exemplary embodiments have been described with reference to the figures, it will be understood by those of ordinary skill in the art that various changes in form and details may be made therein without departing from the spirit and scope of the present invention as defined by the following claims.

What is claimed is:

1. A display device, comprising:
a display panel including data lines which extend in a first direction and a display area which includes a plurality of data areas along a second direction that intersects the first direction;
first flexible films disposed on a first side of the display panel; and
second flexible films disposed on a second side of the display panel,
wherein the first flexible films are electrically connected to data lines in odd-numbered data areas, and
the second flexible films are electrically connected to data lines in even-numbered data areas.

2. The display device of claim 1, wherein a width in the second direction of a first flexible film of the first flexible films is greater than a width in the second direction of an odd-numbered data area connected to the first flexible film.

3. The display device of claim 1, wherein a width in the second direction of a second flexible film of the second flexible films is greater than a width in the second direction of an even-numbered data area connected to the second flexible film.

4. The display device of claim 1, wherein the first flexible films and the second flexible films electrically connected to adjacent data areas of the plurality of data areas partially overlap with each other.

5. The display device of claim 4, wherein an overlapping area in the first direction of the first flexible films and the second flexible films electrically connected to the adjacent data areas is smaller than a non-overlapping area of the first flexible films and the second flexible films electrically connected to the adjacent data areas.

6. The display device of claim 1, further comprising:
first source driving circuits respectively disposed on the first flexible films; and
second source driving circuits respectively disposed on the second flexible films.

7. The display device of claim 6, wherein
the first source driving circuits overlap with the odd-numbered data areas,
the second source driving circuits overlap with the even-numbered data areas, and
the first source driving circuits do not overlap with the second source driving circuits.

8. The display device of claim 1, further comprising:
a first scan driver adjacent to a third side of the display panel; and
a second scan driver adjacent to a fourth side of the display panel,
wherein the display panel further includes scan lines which are electrically connected to the first scan driver and the second scan driver and intersect the data lines and pixels, first scan control signal lines which connect the first scan driver and first pads, and second scan control signal lines which connect the second scan driver and second pads.

9. The display device of claim 8, wherein
a first flexible film of the first flexible films adjacent to the third side of the display panel is electrically connected to the first pads, and
a second flexible film of the second flexible films adjacent to the fourth side of the display panel is electrically connected to the second pads.

10. The display device of claim 9, wherein lengths of the first scan control signal lines are smaller than lengths of the second scan control signal lines.

11. The display device of claim 10, wherein
an odd-numbered data area adjacent to the third side of the display panel is closer to the first scan driver than an even-numbered data area adjacent to the third side of the display panel is to the first scan driver, and
an odd-numbered data area adjacent to the fourth side of the display panel is further away from the second scan driver than an even-numbered data area adjacent to the fourth side of the display panel is from the second scan driver.

12. The display device of claim 10, wherein the first scan driver sequentially outputs scan signals to the scan lines from the first side of the display panel to the second side of the display panel.

13. The display device of claim 9, wherein
the display panel further includes first dummy pads which are adjacent to the first scan driver, and
a second flexible film adjacent to the third side of the display panel is connected to the first dummy pads.

14. The display device of claim 9, wherein
the display panel further includes second dummy pads which are adjacent to the second scan driver, and
the second flexible film adjacent to the fourth side of the display panel is connected to the second dummy pads.

15. A display device, comprising:
a display panel including a plurality of data areas;
each data area of the plurality of data areas includes a first data line and a second data line;
a plurality of pixels disposed in a column between the first data line and the second data line of each data area, wherein adjacent pixels of the plurality of pixels are connected to the first data line and the second data line in an alternating manner;
a first scan driver adjacent to a third side of the display panel and a second scan driver adjacent to a fourth side of the display panel each including scan control signal lines which are electrically connected to outermost ones of the data areas, wherein a first scan control signal line connects the first scan driver and first pads, and a second scan control signal line connects the second scan driver and second pads;
first flexible films disposed on a first side of the display panel with a first distance therebetween;
second flexible films disposed on a second side of the display panel opposite to the first side with a second space therebetween; and
scan lines which are electrically connected to the first scan driver and the second scan driver and intersect the first data line and the second data line and the plurality of pixels,
wherein the first flexible films are electrically connected to odd-numbered data areas,
wherein the second flexible films are electrically connected to even-numbered data areas,
wherein at least some of the scan lines are bifurcated and connect to adjacent pixels in the same column;
wherein a first flexible film of the first flexible films adjacent to the third side of the display panel is electrically connected to the first pads, and
wherein a second flexible film of the second flexible films adjacent to the fourth side of the display panel is electrically connected to the second pads.

16. The display device of claim 15, wherein a length of one of the first scan control signal lines is the same as a length of one of the second scan control signal lines.

17. The display device of claim 16, wherein
an odd-numbered data area adjacent to the third side of the display panel is closer to the first scan driver than an even-numbered data area adjacent to the third side of the display panel is to the first scan driver, and
an odd-numbered data area adjacent to the fourth side of the display panel is further apart than an even-numbered data area adjacent to the fourth side of the display panel from the second scan driver.

18. The display device of claim 15, wherein the first scan driver sequentially outputs scan signals to the scan lines from the first side of the display panel to the second side of the display panel.

19. The display device of claim 15, wherein
the display panel further includes first dummy pads which are adjacent to the first scan driver, and
a second flexible film adjacent to the third side of the display panel is connected to the first dummy pads.

20. The display device of claim 15, wherein
the display panel further includes second dummy pads which are adjacent to the second scan driver, and
a first flexible film adjacent to the fourth side of the display panel is connected to the second dummy pads.
